(19) United States
(12) Patent Application Publication
(10) Pub. No.: US 2023/0144103 A1
(43) Pub. Date: May 11, 2023

(54) METHODS, DEVICES AND COMPUTER STORAGE MEDIA FOR COMMUNICATION

(71) Applicant: NEC CORPORATION, Tokyo (JP)

(72) Inventors: Yukai GAO, Beijing (CN); Gang WANG, Beijing (CN)

(73) Assignee: NEC CORPORATION, Tokyo (JP)

(21) Appl. No.: 17/918,246

(22) PCT Filed: Apr. 10, 2020
(86) PCT No.: PCT/CN2020/084289

§ 371 Date: Oct. 11, 2022

(51) Int. Cl. H04W 72/20; H04W 72/12; H04L 5/00

(52) U.S. Cl. CPC H04W 72/20; H04W 72/12; H04L 5/0094

(57) ABSTRACT

Embodiments of the present disclosure relate to methods, devices and computer readable media for communication. A method comprises: receiving, at a first device, control information from a second device for scheduling a plurality of transmission occasions of a physical shared channel; determining, a plurality of transmission control indication (TCI) states to be used for the plurality of transmission occasions; in response to the plurality of transmission occasions of the physical shared channel being configured to be scheduled by the control information, determining, from the plurality of transmission occasions of the physical shared channel, a set of transmission occasions of the physical shared channel associated with one TCI state of the plurality of TCI states; receiving, at least based on the TCI state, the plurality of transmission occasions from the second device over the physical shared channel.

### TECHNICAL FIELD

Embodiments of the present disclosure generally relate to the field of telecommunication, and in particular, to methods, devices and computer storage media for communication.

### BACKGROUND

The latest developments of the Third Generation Partnership Project (3GPP) standards are referred to as Long Term Evolution (LTE) of Evolved Packet Core (EPC) network and Evolved UMTS Terrestrial Radio Access Network (E-UTRAN), also commonly termed as ‘4G’. In addition, the term ‘5G New Radio (NR)’ refers to an evolving communication technology that is expected to support a variety of applications and services. 5G N_{R} is part of a continuous mobile broadband evolution promulgated by 3GPP to meet new requirements associated with latency, reliability, security, scalability (e.g., with Internet of Things (IoT)), and other requirements. In New Radio access (NR), a network device (for example, a next generation NodeB (gNB)) may be equipped with multiple Transmission and Reception Points (TRPs) or antenna panels. That is, the network device can communicate with a terminal device (for example, a user equipment (UE)) via one or more of the multiple TRPs or antenna panels, which is also referred to as “multi-TRP communication”.

In some Multi-TRP communication schemes, single and/or multiple physical downlink control channel (PDCCH) or downlink control information (DCI) can be used to schedule a number of Physical Downlink Shared Channel (PDSCH) or Physical Uplink Shared Channel (PUSCH) repetitions to achieve better performance. Different versions of redundancy can be included in the number of repetitions. The DCI may include a field indicating a sequence of redundancy versions (also referred to as a “RV sequence” or “sequence of RVs” in the following) to be applied to the number of repetitions. Moreover, the DCI may also include a transmission configuration indication (TCI) filed, which may indicate at least two TCI states. A TCI state may indicate one Reference Signal (RS) set as well as parameters that configure quasi co-location (QCL) relationship between RSs within the RS set and Demodulation Reference Signal (DMRS) ports for a PDSCH or a PUSCH. The number of PDSCH or PUSCH repetitions scheduled by single DCI may be at least one of {1, 2, 3, 4, 5, 6, 7, 8, 16}. In this event, how to assign the TCI states and/or QCL parameters and/or a RV sequence to the number of repetitions needs to be specified.

In the 3GPP meeting RAN#81, a new work item (WI) for N_{R} eMIMO was approved including the following aspects. First, it is to provide enhancements on Multi-user (MU)-Multiple Input Multiple Output (MIMO) support. Specifically, it is to specify overhead reduction, based on Type II Channel State Information (CSI) feedback, taking into account the tradeoff between performance and overhead. It is to perform study and, if needed, specify extension of Type II CSI feedback to rank>2. Second, it is to provide enhancements on multi-TRP/panel transmission including improved reliability and robustness with both ideal and non-ideal backhaul. In particular, it is to specify downlink control signaling enhancement(s) for efficient support of non-coherent joint transmission. It is to perform study and, if needed, specify enhancements on uplink control signaling and/or reference signal(s) for non-coherent joint transmission. Multi-TRP techniques for Ultra-Reliable Low latency Communications (URLLC) requirements are included in this WI.

In the 3GPP meeting RAN#86, enhancements on the support for multi-Transmission and Reception Point (multi-TRP) deployment have been discussed. For example, it has been proposed to identify and specify features to improve reliability and robustness for physical channels (such as, Physical Downlink Control Channel (PDCCH), Physical Uplink Shared Channel (PUSCH) and/or Physical Uplink Control Channel (PUCCH)) other than Physical Downlink Shared Channel (PDSCH) using multi-TRP and/or multi-panel with Release 16 reliability features as a baseline. It has also been proposed to identify and specify features to enable inter-cell multi-TRP operations. It has also been proposed to evaluate and specify enhancements for simultaneous multi-TRP transmissions with multi-panel receptions.

### SUMMARY

In general, example embodiments of the present disclosure provide methods, devices and computer storage media for communication.

In a first aspect, there is provided a method of communication. A method comprises: receiving, at a first device, control information from a second device for scheduling a plurality of transmission occasions of a physical shared channel; determining, a plurality of transmission control indication (TCI) states to be used for the plurality of transmission occasions; in response to the plurality of transmission occasions of the physical shared channel being configured to be scheduled by the control information, determining, from the plurality of transmission occasions of the physical shared channel, a set of transmission occasions of the physical shared channel associated with one TCI state of the plurality of TCI states; receiving, at least based on the TCI state, the plurality of transmission occasions from the second device over the physical shared channel.

In a second aspect, there is provided a device of communication. The device comprises a processor and a memory. The memory is coupled to the processor and stores instructions thereon. The instructions, when executed by the processor, cause the device to perform actions comprising: receiving, at a first device, control information from a second device for scheduling a plurality of transmission occasions of a physical shared channel; determining, a plurality of transmission control indication (TCI) states to be used for the plurality of transmission occasions; in response to the plurality of transmission occasions of the physical shared channel being configured to be scheduled by the control information, determining, from the plurality of transmission occasions of the physical shared channel, a set of transmission occasions of the physical shared channel associated with one TCI state of the plurality of TCI states; receiving, at least based on the TCI state, the plurality of transmission occasions from the second device over the physical shared channel.

In a third aspect, there is provided a computer readable medium having instructions stored thereon. The instructions, when executed on at least one processor, cause the at least one processor to perform the method according to the first aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2 illustrates an example signaling chart showing an example process in accordance with some embodiments of the present disclosure;

FIGS. 3-7 illustrate example diagrams in accordance with some embodiments of the present disclosure;

FIG. 8 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

In the context of the present disclosure, the user equipment and the TRP may be two transmission/reception subjects, having an inclusive meaning, which are used to embody the technology and the technical concept disclosed herein, and may not be limited to a specific term or word. Furthermore, the user equipment and the TRP may be uplink or downlink transmission/reception subjects, having an inclusive meaning, which are used to embody the technology and the technical concept disclosed in connection with the present embodiment, and may not be limited to a specific term or word. Herein, an uplink (UL) transmission/reception is a scheme in which data is transmitted from user equipment to a base station. Alternatively, a downlink (DL) transmission/reception is a scheme in which data is transmitted from the base station to the user equipment.

As used herein, the term “resource,” “transmission resource,” “resource block,” “physical resource block” or “sidelink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, a resource in both frequency domain and time domain will be used as an example of a transmission resource for describing some embodiments of the present disclosure. It is noted that embodiments of the present disclosure are equally applicable to other resources in other domains.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “at least in part based on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

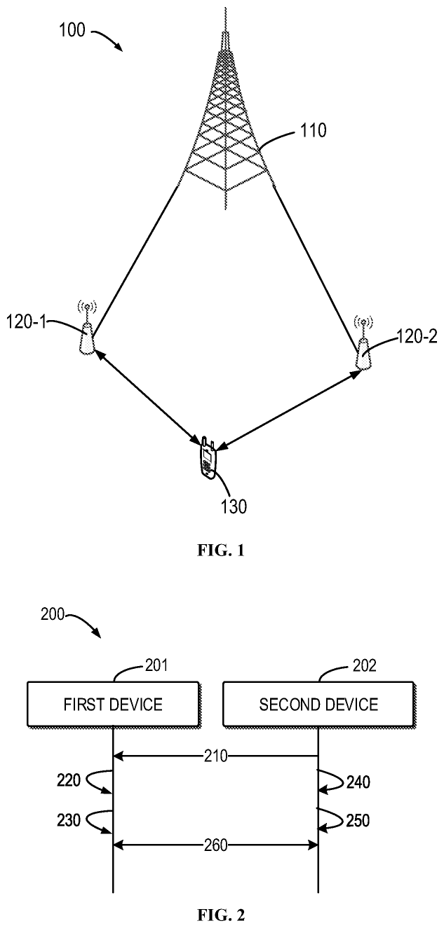

FIG. 1 shows an example communication network 100 in which embodiments of the present disclosure can be implemented. The network 100 includes a network device 110 and a terminal device 120 served by the network device 110. The network 100 may provide one or more serving cells to serve the terminal device 120. Carrier Aggregation (CA) can be supported in the network 100, in which two or more CCs are aggregated in order to support a broader bandwidth. For example, in FIG. 1, the network device 110 may provide to the terminal device 120 a plurality of serving cells including one primary cell (Pcell) 101 corresponding to a primary CC and at least one secondary cell (Scell) 102 corresponding to at least one secondary CC. It is to be understood that the number of network devices, terminal devices and/or serving cells is only for the purpose of illustration without suggesting any limitations to the present disclosure. The network 100 may include any suitable number of network devices, terminal devices and/or serving cells adapted for implementing implementations of the present disclosure.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. For the purpose of discussion, in the following, some embodiments will be described with reference to UE as an example of the terminal device 120.

As used herein, the term ‘network device’ or ‘base station’ (BS) refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

In one embodiment, the terminal device 120 may be connected with a first network device and a second network device (not shown in FIG. 1). One of the first network device and the second network device may be in a master node and the other one may be in a secondary node. The first network device and the second network device may use different radio access technologies (RATs). In one embodiment, the first network device may be a first RAT device and the second network device may be a second RAT device. In one embodiment, the first RAT device may be an eNB and the second RAT device is a gNB. Information related to different RATs may be transmitted to the terminal device 120 from at least one of the first network device and the second network device. In one embodiment, first information may be transmitted to the terminal device 120 from the first network device and second information may be transmitted to the terminal device 120 from the second network device directly or via the first network device. In one embodiment, information related to configuration for the terminal device configured by the second network device may be transmitted from the second network device via the first network device. Information related to reconfiguration for the terminal device configured by the second network device may be transmitted to the terminal device from the second network device directly or via the first network device. The information may be transmitted via any of the following: Radio Resource Control (RRC) signaling, Medium Access Control (MAC) control element (CE) or Downlink Control Information (DCI).

In the communication network 100 as shown in FIG. 1, the network device 110 can communicate data and control information to the terminal device 120 and the terminal device 120 can also communication data and control information to the network device 110. A link from the network device 110 to the terminal device 120 is referred to as a downlink (DL), while a link from the terminal device 120 to the network device 110 is referred to as an uplink (UL).

In some embodiments, for downlink transmissions, the network device 110 may transmit control information via a PDCCH and/or transmit data via a PDSCH to the terminal device 120. Additionally, the network device 110 may transmit one or more reference signals (RSs) to the terminal device 120. The RS transmitted from the network device 110 to the terminal device 120 may also referred to as a “DL RS”. Examples of the DL RS may include but are not limited to Demodulation Reference Signal (DMRS), Channel State Information-Reference Signal (CSI-RS), Sounding Reference Signal (SRS), Phase Tracking Reference Signal (PTRS), fine time and frequency Tracking Reference Signal (TRS) and so on.

In some embodiments, for uplink transmissions, the terminal device 120 may transmit control information via a PUCCH and/or transmit data via a PUSCH to the network device 110. Additionally, the terminal device 120 may transmit one or more RSs to the network device 110. The RS transmitted from the terminal device 120 to the network device 110 may also referred to as a “UL RS”. Examples of the UL RS may include but are not limited to DMRS, CSI-RS, SRS, PTRS, fine time and frequency TRS and so on.

The communications in the network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

The network device 110 (such as, a gNB) may be equipped with one or more TRPs or antenna panels. As used herein, the term “TRP” refers to an antenna array (with one or more antenna elements) available to the network device located at a specific geographical location. For example, a network device may be coupled with multiple TRPs in different geographical locations to achieve better coverage. The one or more TRPs may be included in a same serving cell or different serving cells.

It is to be understood that the TRP can also be a panel, and the panel can also refer to an antenna array (with one or more antenna elements). Although some embodiments of the present disclosure are described with reference to multiple TRPs for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

As shown in FIG. 1, for example, the network device 110 may communicate with the terminal device 120 via TRPs 130-1 and 130-2. In the following text, the TRP 130-1 may be also referred to as the first TRP, while the TRP 130-2 may be also referred to as the second TRP. The first and second TRPs 130-1 and 130-2 may be included in same serving cells (such as, the serving cells 101 and 102 as shown in FIG. 1) or different serving cells provided by the network device 110. Although some embodiments of the present disclosure are described with reference to the first and second TRPs 130-1 and 130-2 within same serving cells provided by the network device 110, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

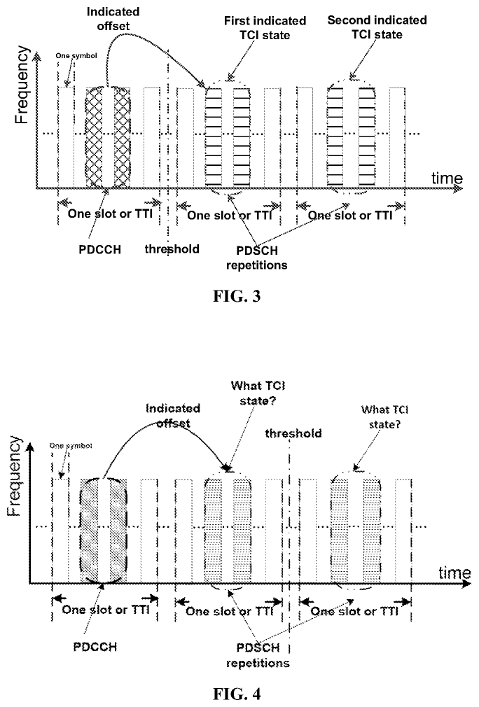

FIG. 2 illustrates a signaling chart of an example process 200 of communication in accordance with some embodiments of the present disclosure. The process 200 involves the network device 110 and the terminal device 120 as shown in FIG. 1 and/or FIG. 1B.

As shown in FIG. 2, the network device 110 may transmit (201) one or more PDCCHs for scheduling a plurality of transmissions occasions (such as, PDSCH repetitions) to the terminal device 120. The terminal device 120 may receive (201) the one or more PDCCHs from the network device 110. For example, none or at least one of the PDCCHs may be received by the terminal device 120. The network device 110 may perform (202) the transmission occasions to the terminal device 120 based on one or more PDCCHs. The terminal device 120 may decode (202) the transmission occasions from the network device 110 and transmit (203), based on the decoding of the downlink transmissions, a feedback sequence for the transmission occasions to the network device 110. The network device 110 may receive (203) the feedback sequence for the downlink transmissions from the terminal device 120.

In some embodiments, the first and second TRPs 120-1 and 120-2 may be explicitly associated with different higher-layer configured identities. For example, a higher-layer configured index can be associated with a pre-defined Control Resource Set (CORESET), a pre-defined reference signal (RS), or a pre-defined Transmission Configuration Indication (TCI) state, which is used to differentiate between transmissions between different TRPs and the terminal device 130. When the terminal device 130 receives two DCIs from two CORESETs which are associated with different higher-layer configured identities, the two DCIs are indicated from different TRPs. Further, the first and second TRPs 120-1 and 120-2 may be implicitly identified by a dedicated configuration to the physical channels or signals. For example, a dedicated CORESET, a RS, and a TCI state, which are associated with a TRP, are used to identify a transmission from a different TRP to the terminal device 130. For example, when the terminal device 130 receives a DCI from a dedicated CORESET, the DCI is indicated from the associated TRP dedicated by the CORESET.

As described above, in some Multi-TRP communication schemes, single and/or multiple PDCCH (or DCI) can be used to schedule a number PDSCH or PUSCH transmission occasions and/or repetitions and/or transmissions and/or receptions to achieve better performance. The number of PDSCH or PUSCH repetitions scheduled by single DCI may be at least one of {1, 2, 3, 4, 5, 6, 7, 8 or 16}. Different versions of redundancy can be included in the number of repetitions. The DCI may include a field indicating a sequence of RVs to be applied to the number of repetitions.

In the repeated transmission or reception via the two TRPs 120-1 and 120-2, the network device 110 may use a repetition scheme among a number of available repetition schemes. The repetition scheme may specify a transmission manner for the network device 110 to use the two TRPs 120-1 and 120-2 cooperatively, for example, a multiplexing scheme between the two TRPs 120-1 and 120-2, the respective resource allocations for the two TRPs 120-1 and 120-2, or the like.

For example, to facilitate further down-selection for one or more schemes in the 3GPP meeting RAN1#96bis, some schemes for multi-TRP based URLLC scheduled by single DCI at least are clarified as following.

Scheme 1 (SDM): n (n<=Nₛ) TCI states within the single slot, with overlapped time and frequency resource allocation.

Scheme 1a: Each transmission occasion is a layer or a set of layers of the same TB (transport block), with each layer or layer set is associated with one TCI and one set of DMRS port(s). Single codeword with one RV is used across all spatial layers or layer sets. From the UE perspective, different coded bits are mapped to different layers or layer sets with the same mapping rule as in Rel-15.

Scheme 1b: Each transmission occasion is a layer or a set of layers of the same TB, with each layer or layer set is associated with one TCI and one set of DMRS port(s). Single codeword with one RV is used for each spatial layer or layer set. The RVs corresponding to each spatial layer or layer set can be the same or different. Codeword-to-layer mapping when total number of layers <=4 is for future study.

Scheme 1c: One transmission occasion is one layer of the same TB with one DMRS port associated with multiple TCI state indices, or one layer of the same TB with multiple DMRS ports associated with multiple TCI state indices one by one.

In addition, it is indicated that applying different MCS/modulation orders for different layers or layer sets can be discussed.

Scheme 2 (FDM): n (n<=N_{f}) TCI states are within the single slot, with non-overlapped frequency resource allocation. Each non-overlapped frequency resource allocation is associated with one TCI state. Same single/multiple DMRS port(s) are associated with all non-overlapped frequency resource allocations.

Scheme 2a: Single codeword with one RV is used across full resource allocation. From UE perspective, the common RB mapping (codeword to layer mapping as in Rel-15) is applied across full resource allocation.

Scheme 2b: Single codeword with one RV is used for each non-overlapped frequency resource allocation. The RVs corresponding to each non-overlapped frequency resource allocation can be the same or different.

In addition, it is indicated that applying different MCS/modulation orders for different non-overlapped frequency resource allocations can be discussed. It is also indicated that details of frequency resource allocation mechanism for FDM 2a/2b with regarding to allocation granularity, time domain allocation can be discussed.

Scheme 3 (TDM): n (n<=Nₜi) TCI states within the single slot, with non-overlapped time resource allocation. Each transmission occasion of the TB has one TCI and one RV with the time granularity of mini-slot. All transmission occasion(s) within the slot use a common MCS with same single or multiple DMRS port(s). RV/TCI state can be same or different among transmission occasions. Channel estimation interpolation across mini-slots with the same TCI index is for future study.

Scheme 4 (TDM): n (n<=Nₜ2) TCI states with K (n<=K) different slots. Each transmission occasion of the TB has one TCI and one RV. All transmission occasion (s) across K slots use a common MCS with same single or multiple DMRS port(s). RV/TCI state can be same or different among transmission occasions. Channel estimation interpolation across slots with the same TCI index is for future study. It is noted that M-TRP/panel based URLLC schemes shall be compared in terms of improved reliability, efficiency, and specification impact. It is noted that support of number of layers per TRP may be discussed.

In some embodiments, the control information may be a DCI as defined in the 3GPP specifications, which can indicate various transmission parameters dynamically, namely, on a relatively short time scale. In some other embodiments, the control information may be a Radio Resource Control (RRC) message or a Medium Access Control (MAC) Control Element (CE) message, which can indicate various transmission parameters semi-statically, that is, on a relatively long time scale.

Although some embodiments of the present disclosure are described with reference to the first and second TRPs within a same serving cell or with different serving cells, these embodiments are only for the purpose of illustration and help those skilled in the art to understand and implement the present disclosure, without suggesting any limitations on the scope of the present disclosure. It is to be understood that embodiments of the present disclosure described herein can be implemented in various manners other than the ones described below.

It is to be understood that the number of network devices, the number of terminal devices, and the number of TRPs as shown in FIG. 1 are only for the purpose of illustration without suggesting any limitations. Actually, the communication environment 100 may include any suitable number of network devices, any suitable number of terminal devices, and any suitable number of TRPs adapted for implementing embodiments of the present disclosure. In other words, embodiments of the present disclosure may also be applicable to a scenario where a terminal device communicates with more than one network device, or a network device coupled with more than two TRPs.

In the following, the terms “transmission occasions”, “repetitions”, “PDSCH transmission occasions”, “PDSCH repetitions”, “PUSCH transmission occasions”, “PUSCH repetitions”, “repeated transmissions”, “repeated receptions”, “PDSCH transmissions”, “PDSCH receptions”, “PUSCH transmissions”, “PUSCH receptions”, “transmissions” and “receptions” can be used interchangeably. The terms “TCI state”, “set of QCL parameter(s)”, “QCL parameter(s)”, “QCL assumption” and “QCL configuration” can be used interchangeably.

As specified in the 3GPP specifications (TS 38.214), a UE can be configured with a list of up to M TCI-State configurations within the higher layer parameter PDSCH-Config to decode PDSCH according to a detected PDCCH with DCI intended for the UE and the given serving cell, where M depends on the UE capability maxNumberConfiguredTClstatesPerCC. Each TCI-State contains parameters for configuring a quasi co-location relationship between one or two downlink reference signals and the DMRS ports of the PDSCH, the DMRS port of PDCCH or the channel state information reference signal (CSI-RS) port(s) of a CSI-RS resource. The quasi co-location relationship is configured by the higher layer parameter qcl-Typel for the first downlink (DL) RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

The UE receives an activation command, as described in clause “TCI States Activation/Deactivation for UE-specific PDSCH MAC CE” (for example, clause 6.1.3.14) of [TS 38.321] or in clause “Enhanced TCI States Activation/Deactivation for UE-specific PDSCH MAC CE” (for example, clause 6.1.3) of [TS 38.321], used to map up to 8 TCI states to the codepoints of the DCI field ‘Transmission Configuration Indication’ in one CC/DL BWP or in a set of CCs/DL BWPs, respectively. When a set of TCI state IDs are activated for a set of CCs/DL BWPs, where the applicable list of CCs is determined by indicated CC in the activation command, the same set of TCI state IDs are applied for all DL BWPs in the indicated CCs.

When a UE supports two TCI states in a codepoint of the DCI field ‘Transmission Configuration Indication’ the UE may receive an activation command, as described in clause “TCI States Activation/Deactivation for UE-specific PDSCH MAC CE” or clause “Enhanced TCI States Activation/Deactivation for UE-specific PDSCH MAC CE” (for example, clause 6.1.3.14 or subclause under 6.1.3) of [TS 38.321], the activation command is used to map up to 8 combinations of one or two TCI states to the codepoints of the DCI field ‘Transmission Configuration Indication’. The UE is not expected to receive more than 8 TCI states in the activation command.

When the UE would transmit a PUCCH with HARQ-ACK information in slot n corresponding to the PDSCH carrying the activation command, the indicated mapping between TCI states and codepoints of the DCI field ‘Transmission Configuration Indication’ should be applied starting from the first slot that is after slot n+ Nₛₗₒₜ^{subframe},μ where □ is the SCS configuration for the PUCCH

As specified in the 3GPP specifications (TS 38.214), if a UE is configured with the higher layer parameter tci-PresentInDCI that is set as ‘enabled’ or tci-PresentInDCI-ForFormat1_2 is configured for the CORESET scheduling the PDSCH, the UE assumes that the TCI field is present in the DCI (for example DCI format1_1 or DCI format 1_2) of the PDCCH transmitted on the CORESET. If tci-PresentInDCI or tci-PresentInDCI-ForFormat1_2 is not configured for the CORESET scheduling the PDSCH or the PDSCH is scheduled by a DCI (for example, DCI format 1_0), the UE assumes that the TCI field is not present in the DCI (for example DCI format 1_1 or DCI format 1_2 or DCI format 1_0) of the PDCCH transmitted on the CORESET.

If tci-PresentInDCI is set to “enabled” or tci-PresentInDCI-ForFormat1_2 is configured for the CORESET scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command, the UE may assume that the DMRS ports of PDSCH of a serving cell are quasi co-located with the SS/PBCH block determined in the initial access procedure with respect to ‘QCL-TypeA’, and when applicable, also with respect to ‘QCL-TypeD’. The value of timeDurationForQCL is based on reported UE capability.

If a UE is configured with the higher layer parameter tci-PresentInDCI that is set as ‘enabled’ for the CORESET scheduling the PDSCH, the UE assumes that the TCI field is present in the DCI (for example, DCI format 1_1) of the PDCCH transmitted on the CORESET. If a UE is configured with the higher layer parameter tci-PresentInDCI-ForFormat1_2 for the CORESET scheduling the PDSCH, the UE assumes that the TCI field with a DCI field size indicated by tci-PresentInDCI-ForFormat1_2 is present in the DCI (for example, DCI format 1_2) of the PDCCH transmitted on the CORESET. If the PDSCH is scheduled by a DCI format not having the TCI field present, and the time offset between the reception of the DL DCI and the corresponding PDSCH is equal to or greater than a threshold timeDurationForQCL if applicable, where the threshold is based on reported UE capability [TS 38.306], for determining PDSCH antenna port quasi co-location, the UE assumes that the TCI state or the QCL assumption for the PDSCH is identical to the TCI state or QCL assumption whichever is applied for the CORESET used for the PDCCH transmission.

If the PDSCH is scheduled by a DCI format having the TCI field present, the TCI field in DCI in the scheduling component carrier points to the activated TCI states in the scheduled component carrier or DL BWP, the UE shall use the TCI-State according to the value of the ‘Transmission Configuration Indication’ field in the detected PDCCH with DCI for determining PDSCH antenna port quasi co-location. The UE may assume that the DM-RS ports of PDSCH of a serving cell are quasi co-located with the RS(s) in the TCI state with respect to the QCL type parameter(s) given by the indicated TCI state if the time offset between the reception of the DL DCI and the corresponding PDSCH is equal to or greater than a threshold timeDurationForQCL, where the threshold is based on reported UE capability [TS 38.306]. When the UE is configured with a single slot PDSCH, the indicated TCI state should be based on the activated TCI states in the slot with the scheduled PDSCH. When the UE is configured with a multi-slot PDSCH, the indicated TCI state should be based on the activated TCI states in the first slot with the scheduled PDSCH, and UE shall expect the activated TCI states are the same across the slots with the scheduled PDSCH. When the UE is configured with CORESET associated with a search space set for cross-carrier scheduling, and the PDCCH carrying the scheduling DCI and the PDSCH scheduled by that DCI are transmitted on the same carrier, the UE expects tci-PresentInDCI is set as ‘enabled’ or tci-PresentInDCI-ForFormat1_2 is configured for the CORESET, and if one or more of the TCI states configured for the serving cell scheduled by the search space set contains ‘QCL-TypeD’, the UE expects the time offset between the reception of the detected PDCCH in the search space set and the corresponding PDSCH is larger than or equal to the threshold timeDurationForQCL.

Independent of the configuration of tci-PresentInDCI and tci-PresentInDCI-ForFormat1_2 in RRC connected mode, if no TCI codepoints are mapped to two different TCI states and the offset between the reception of the DL DCI and the corresponding PDSCH is less than the threshold timeDurationForQCL, the UE may assume that the DM-RS ports of PDSCH of a serving cell are quasi co-located with the RS(s) with respect to the QCL parameter(s) used for PDCCH quasi co-location indication of the CORESET associated with a monitored search space with the lowest controlResourceSetld in the latest slot in which one or more CORESETs within the active BWP of the serving cell are monitored by the UE. In this case, if the ‘QCL-TypeD’ of the PDSCH DM-RS is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers). If none of configured TCI states for the serving cell of scheduled PDSCH contains ‘QCL-TypeD’, the UE shall obtain the other QCL assumptions from the indicated TCI states for its scheduled PDSCH irrespective of the time offset between the reception of the DL DCI and the corresponding PDSCH. If a UE configured by higher layer parameter PDCCH-Config that contains two different values of CORESETPoolIndex in ControlResourceSet, for both cases, when tci-PresentInDCI is set to ‘enabled’ and tci-PresentInDCI is not configured in RRC connected mode, if the offset between the reception of the DL DCI and the corresponding PDSCH is less than the threshold timeDurationForQCL, the UE may assume that the DM-RS ports of PDSCH associated with a value of CORESETPoolIndex of a serving cell are quasi co-located with the RS(s) with respect to the QCL parameter(s) used for PDCCH quasi co-location indication of the CORESET associated with a monitored search space with the lowest CORESET-ID among CORESETs, which are configured with the same value of CORESETPoolIndex as the PDCCH scheduling that PDSCH, in the latest slot in which one or more CORESETs associated with the same value of CORESETPoolIndex as the PDCCH scheduling that PDSCH within the active BWP of the serving cell are monitored by the UE. If the offset between the reception of the DL DCI and the corresponding PDSCH is less than the threshold timeDurationForQCL and at least one configured TCI states for the serving cell of scheduled PDSCH contains the ‘QCL-TypeD’, and at least one TCI codepoint indicates two TCI states, the UE may assume that the DM-RS ports of PDSCH of a serving cell are quasi co-located with the RS(s) with respect to the QCL parameter(s) associated with the TCI states corresponding to the lowest codepoint among the TCI codepoints containing two different TCI states.

If the PDCCH carrying the scheduling DCI is received on one component carrier, and the PDSCH scheduled by that DCI is on another component carrier: The timeDurationForQCL is determined based on the subcarrier spacing of the scheduled PDSCH. If μPDCCH<μPDSCH an additional timing delay d is added to the timeDurationForQCL, where d is defined as 8 symbols if subcarrier spacing for the PDCCH is 15 kHz, or 8 symbols if subcarrier spacing for the PDCCH is 30 kHz, or 14 symbols if subcarrier spacing for the PDCCH is 60 kHz. For example, the symbol is PDCCH symbol, or the symbol is based on the subcarrier spacing of PDCCH (for example, as defined in Table 5.2.1.5.1a-1 of TS 38.214); For both the cases when tci-PresentInDCI is set to ‘enabled’ and the offset between the reception of the DL DCI and the corresponding PDSCH is less than the threshold timeDurationForQCL and when tci-PresentInDCI is not configured, the UE obtains its QCL assumption for the scheduled PDSCH from the activated TCI state with the lowest ID applicable to PDSCH in the active BWP of the scheduled cell.

As specified in the 3GPP specifications (TS 38.214), when a UE is configured by higher layer parameter RepSchemeEnabler set to one of ‘FDMSchemeA’, ‘FDMSchemeB’, ‘TDMSchemeA’, if the UE is indicated with two TCI states in a codepoint of the DCI field ‘Transmission Configuration Indication’ and DMRS port(s) within one CDM (Code Domain Multiplexing) group in the DCI field “Antenna Port(s)”. When two TCI states are indicated in a DCI and the UE is set to ‘FDMSchemeA’, the UE shall receive a single PDSCH transmission occasion of the TB with each TCI state associated to a non-overlapping frequency domain resource allocation as described in clause “Physical resource block (PRB) bundling” (for example Clause 5.1.2.3) in TS 38.214. When two TCI states are indicated in a DCI and the UE is set to ‘FDMSchemeB’, the UE shall receive two PDSCH transmission occasions of the same TB with each TCI state associated to a PDSCH transmission occasion which has non-overlapping frequency domain resource allocation with respect to the other PDSCH transmission occasion as described in clause “Physical resource block (PRB) bundling” (for example Clause 5.1.2.3) in TS 38.214. When two TCI states are indicated in a DCI and the UE is set to ‘TDMSchemeA’, the UE shall receive two PDSCH transmission occasions of the same TB with each TCI state associated to a PDSCH transmission occasion which has non-overlapping time domain resource allocation with respect to the other PDSCH transmission occasion and both PDSCH transmission occasions shall be received within a given slot as described in Clause “Resource allocation in time domain” (for example, clause 5.1.2.1) in TS 38.214.

When a UE is configured by the higher layer parameter PDSCH-config that indicates at least one entry in pdsch-TimeDomainAllocationList containing RepNumR16 in PDSCH-TimeDomainResourceAllocation, the UE may expect to be indicated with one or two TCI states in a codepoint of the DCI field ‘Transmission Configuration Indication’ together with the DCI field “Time domain resource assignment’ indicating an entry in pdsch-TimeDomainAllocationList which contain RepNum16 in PDSCH-TimeDomainResourceAllocation and DM-RS port(s) within one CDM group in the DCI field “Antenna Port(s)”. When two TCI states are indicated in a DCI with ‘Transmission Configuration Indication’ field, the UE may expect to receive multiple slot level PDSCH transmission occasions of the same TB with two TCI states used across multiple PDSCH transmission occasions as defined in Clause “Resource allocation in time domain” (for example, clause 5.1.2.1) in TS 38.214. When one TCI state is indicated in a DCI with ‘Transmission Configuration Indication’ field, the UE may expect to receive multiple slot level PDSCH transmission occasions of the same TB with one TCI state used across multiple PDSCH transmission occasions as defined in Clause “Resource allocation in time domain” (for example, clause 5.1.2.1) in TS 38.214.

When a UE is not indicated with a DCI that DCI field “Time domain resource assignment’ indicating an entry in pdsch-TimeDomainAllocationList which contain RepNumR16 in PDSCH-TimeDomainResourceAllocation, and it is indicated with two TCI states in a codepoint of the DCI field ‘Transmission Configuration Indication’ and DM-RS port(s) within two CDM groups in the DCI field “Antenna Port(s)”, the UE may expect to receive a single PDSCH where the association between the DM-RS ports and the TCI states are as defined in Clause “DMRS reception procedure” (for example, clause 5.1.6.2) in TS 38.214.

When a UE is not indicated with a DCI that DCI field “Time domain resource assignment’ indicating an entry in pdsch-TimeDomainAllocationList which contain RepNumR16 in PDSCH-TimeDomainResourceAllocation, and it is indicated with one TCI states in a codepoint of the DCI field ‘Transmission Configuration Indication’, the UE procedure for receiving the PDSCH upon detection of a PDCCH follows Clause “UE procedure for receiving the physical downlink shared channel” (for example, Clause 5.1) in TS 38.214.

In the following, the terms “FDMSchemeA” and “Scheme 2a” can be used interchangeably. The terms “FDMSchemeB” and “Scheme 2b” can be used interchangeably. The terms “TDMSchemeA” and “Scheme 3” can be used interchangeably. The terms “RepNumR16” and “Scheme 4” can be used interchangeably.

As specified in the 3GPP specifications (TS 38.214), when a UE is configured by the higher layer parameter RepSchemeEnabler set to ‘TDMSchemeA’ and indicated DM-RS port(s) within one CDM group in the DCI field “Antenna Port(s)”, the number of PDSCH transmission occasions is derived by the number of TCI states indicated by the DCI field ‘Transmission Configuration Indication’ of the scheduling DCI. If two TCI states are indicated by the DCI field ‘Transmission Configuration Indication’, the UE is expected to receive two PDSCH transmission occasions, where the first TCI state is applied to the first PDSCH transmission occasion and resource allocation in time domain for the first PDSCH transmission occasion follows Clause “Resource allocation in time domain” (for example, clause 5.1.2.1) in TS 38.214. The second TCI state is applied to the second PDSCH transmission occasion, and the second PDSCH transmission occasion shall have the same number of symbols as the first PDSCH transmission occasion. If the UE is configured by the higher layers with a value K̅ in StartingSymbolOffsetK, it shall determine that the first symbol of the second PDSCH transmission occasion starts after K̅ symbols from the last symbol of the first PDSCH transmission occasion. If the value K̅ is not configured via the higher layer parameter StartingSymbolOffsetK, K̅=0 shall be assumed by the UE. The UE is not expected to receive more than two PDSCH transmission layers for each PDSCH transmission occasion. For two PDSCH transmission occasions, the redundancy version to be applied is derived according to Table 5.1.2.1-2 in TS 38.214, where n=0, 1 applied respectively to the first and second TCI state. Otherwise, the UE is expected to receive a single PDSCH transmission occasion, and the resource allocation in the time domain follows Clause “Resource allocation in time domain” (for example, clause 5.1.2.1) in TS 38.214.

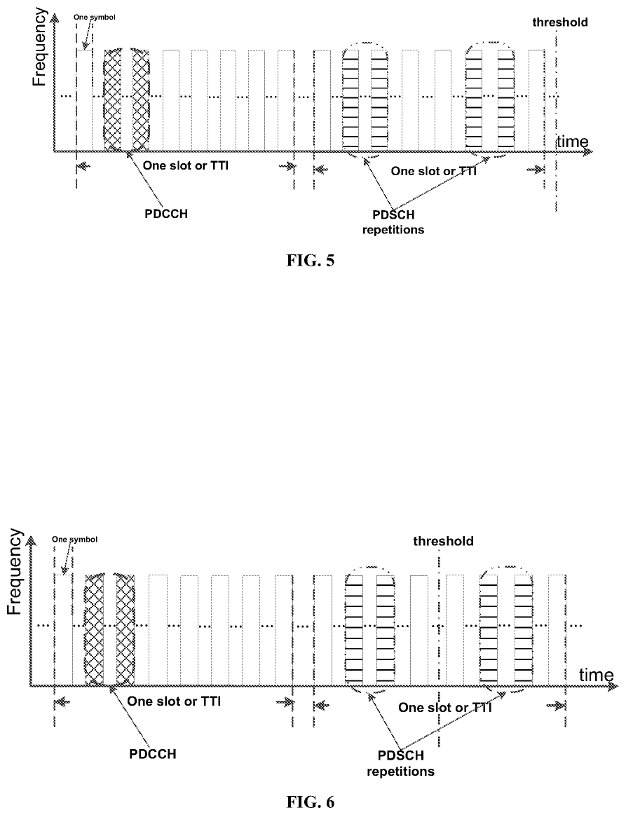

As specified in the 3GPP specifications (TS 38.214), when a UE configured by the higher layer parameter PDSCH-config that indicates at least one entry in pdsch-TimeDomainAllocationList contain RepNumR16 in PDSCH-TimeDomainResourceAllocation. If two TCI states are indicated by the DCI field ‘Transmission Configuration Indication’ together with the DCI field “Time domain resource assignment’ indicating an entry in pdsch-TimeDomainAllocationList which contain RepNumR16 in PDSCH-TimeDomainResourceAllocation and DM-RS port(s) within one CDM group in the DCI field “Antenna Port(s)”, the same SLIV (Start and length indicator value) is applied for all PDSCH transmission occasions, the first TCI state is applied to the first PDSCH transmission occasion and resource allocation in time domain for the first PDSCH transmission occasion follows Clause “Resource allocation in time domain” (for example, clause 5.1.2.1) in TS 38.214. When the value indicated by RepNumR16 in PDSCH-TimeDomainResourceAllocation equals to two, the second TCI state is applied to the second PDSCH transmission occasion. When the value indicated by RepNumR16 in PDSCH-TimeDomainResourceAllocation is larger than two, the UE may be further configured to enable CycMapping or SeqMapping in RepTClMapping. When CycMapping is enabled, the first and second TCI states are applied to the first and second PDSCH transmission occasions, respectively, and the same TCI mapping pattern continues to the remaining PDSCH transmission occasions. When SeqMapping is enabled, first TCI state is applied to the first and second PDSCH transmissions, and the second TCI state is applied to the third and fourth PDSCH transmissions, and the same TCI mapping pattern continues to the remaining PDSCH transmission occasions. The UE may expect that each PDSCH transmission occasion is limited to two transmission layers. For all PDSCH transmission occasions associated with the first TCI state, the redundancy version to be applied is derived according to Table 5.1.2.1-2 [TS 38.214], where n is counted only considering PDSCH transmission occasions associated with the first TCI state. The redundancy version for PDSCH transmission occasions associated with the second TCI state is derived according to Table 5.1.2.1-3 [TS 38.214], where additional shifting operation for each redundancy version rvₛ is configured by higher layer parameter RVSeqOffset and n is counted only considering PDSCH transmission occasions associated with the second TCI state. If one TCI state is indicated by the DCI field ‘Transmission Configuration Indication’ together with the DCI field “Time domain resource assignment’ indicating an entry in pdsch-TimeDomainAllocationList which contain RepNumR16 in PDSCH-TimeDomainResourceAllocation and DM-RS port(s) within one CDM group in the DCI field “Antenna Port(s)”, the same SLIV is applied for all PDSCH transmission occasions, the first PDSCH transmission occasion follows Clause “Resource allocation in time domain” (for example, clause 5.1.2.1) in TS 38.214, the same TCI state is applied to all PDSCH transmission occasions. The UE may expect that each PDSCH transmission occasion is limited to two transmission layers. For all PDSCH transmission occasions, the redundancy version to be applied is derived according to Table 5.1.2.1-2 [TS 38.214], where n is counted considering PDSCH transmission occasions. Otherwise, the UE is expected to receive a single PDSCH transmission occasion, and the resource allocation in the time domain follows Clause “Resource allocation in time domain” (for example, clause 5.1.2.1) in TS 38.214. For example, as shown in FIG. 3.

TABLE 5.1.2.1-2
Applied redundancy version when pdsch-
AggregationFactor is present

| rv_{id} indicated | rv_{id} to be applied to n^{th} | | | |
|---|---|---|---|---|
| by the DCI | transmission occasion | | | |
| scheduling | n mod | n mod | n mod | n mod |
| the PDSCH | 4 = 0 | 4 = 1 | 4 = 2 | 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

TABLE 5.1.2.1-3
Applied redundancy version for the second TCI state when RVSeqOffset is
present

| | rv_{id} to be applied to n^{th} transmission occasion with second TCI state | | | | | | | |
|---|---|---|---|---|---|---|---|---|
| rv_{id} indicated | | | | | | | | |
| by the DCI | | | | | | | | |
| scheduling the | | | | | | | | |
| PDSCH | n mod 4 = 0 | | n mod 4 = 1 | | n mod 4 = 2 | | n mod 4 = 3 | |
| 0 | (0 + rvₛ) | mod 4 | (2 + rvₛ) | mod 4 | (3 + rvₛ) | mod 4 | (1 + rvₛ) | mod 4 |
| 2 | (2 + rvₛ) | mod 4 | (3 + rvₛ) | mod 4 | (1 + rvₛ) | mod 4 | (0 + rvₛ) | mod 4 |
| 3 | (3 + rvₛ) | mod 4 | (1 + rvₛ) | mod 4 | (0 + rvₛ) | mod 4 | (2 + rvₛ) | mod 4 |
| 1 | (1 + rvₛ) | mod 4 | (0 + rvₛ) | mod 4 | (2 + rvₛ) | mod 4 | (3 + rvₛ) | mod 4 |

As specified in the 3GPP specifications (TS 38.214), For a UE configured by the higher layer parameter RepSchemeEnabler set to ‘FDMSchemeA’ or ‘FDMSchemeB’, and when the UE is indicated with two TCI states in a codepoint of the DCI field ‘Transmission Configuration Indication and DM-RS port(s) within one CDM group in the DCI field “Antenna Port(s)”. If P′_{BWP,i} is determined as “wideband”, the first

$$⌈ \frac{{n}_{P R B}}{2} ⌉$$

PRBs are assigned to the first TCI state and the remaining

$$⌊ \frac{{n}_{P R B}}{2} ⌋$$

are assigned to the second TCI state, where n_{PRB} is the total number of allocated PRBs for the UE. If P′_{BWP, i} is determined as one of the values among {2, 4}, even PRGs within the allocated frequency domain resources are assigned to the first TCI state and odd PRGs within the allocated frequency domain resources are assigned to the second TCI state. The UE is not expected to receive more than two PDSCH transmission layers for each PDSCH transmission occasion.

For a UE configured by the higher layer parameter RepSchemeEnabler set to ‘FDMSchemeB’, and when the UE is indicated with two TCI states in a codepoint of the DCI field ‘Transmission Configuration Indication and DM-RS port(s) within one CDM group in the DCI field “Antenna Port(s)”, each PDSCH transmission occasion shall follow the Clause “Physical downlink shared channel” (for example Clause 7.3.1) of [TS 38.211] with the mapping to resource elements determined by the assigned PRBs for corresponding TCI state of the PDSCH transmission occasion, and the UE shall only expect at most two code blocks per PDSCH transmission occasion when a single transmission layer is scheduled and a single code block per PDSCH transmission occasion when two transmission layers are scheduled. For two PDSCH transmission occasions, the redundancy version to be applied is derived according to Table 5.1.2.1-2 of [TS 38.214], where n=0, 1 are applied to the first and second TCI state, respectively.

In conventional solutions, for scheme 2a, scheme 2b, scheme 3 and scheme 4, the number of transmission occasions and/or TCI states and/or QCL parameters for the transmission occasions is described if the TCI field is present in DCI and the time offset between the reception of the DL DCI and the corresponding PDSCH is equal to or greater than timeDurationForQCL. For example, the tci-PresentInDCI is set as ‘enabled’ or tci-PresentInDCI-ForFormat1_2 is configured for the CORESET. A TCI state may indicate one RS set as well as parameters that configure QCL relationship between RSs within the RS set and DMRS ports for a PDSCH or a PUSCH. If the time offset between the reception of the DL DCI and the corresponding PDSCH is less than timeDurationForQCL and/or the TCI field is not present in DCI (For example, the tci-PresentInDCI not configured and/or tci-PresentInDCI-ForFormat1_2 is not configured for the CORESET). The number of transmission occasions and/or the TCI states and/or QCL parameters for the transmission occasion(s) is not defined. In this event, how to define the number of transmission occasions and/or how to assign the TCI states and/or QCL parameters to the transmission occasions needs to be specified. For example, as shown in FIG. 4.

Example embodiments of the present disclosure provide a solution for multi-TRP communication. This solution can determine number of transmission occasions and/or assign TCI states and/or QCL parameters to a number of PDSCH or PUSCH repetitions so as to achieve better decoding performance of the PDSCH or PUSCH.

FIG. 2 illustrates an example signaling chart showing an example process 200 in accordance with some embodiments of the present disclosure. As shown in FIG. 2, the process 200 may involve a first device 201 and a second device 202. In some embodiments, for example, the first device 201 may be the terminal device 130 as shown in FIG. 1. In some embodiments, for example, the second device 202 may be the network device 110 or the TRP 120 as shown in FIG. 1. It is to be understood that the process 200 may include additional acts not shown and/or may omit some acts as shown, and the scope of the present disclosure is not limited in this regard.

As shown in FIG. 2, the second device 202 may transmit 210 control information (such as, DCI) to the first device 201. The control information may schedule a number of repetitions of a PDSCH or a PUSCH. The control information may include information for scheduling the PDSCH (such as, the repetitions of the PDSCH) or the PUSCH (such as, the repetitions of the PUSCH). In response to receiving the control information from the second device 202, the first device 201 may determine 220 the information for scheduling the PDSCH or the PUSCH from the control information. The first device 201 may determine 230 one or more configurations for receiving the one or more repetitions of the PDSCH from the second device or transmitting the one or more repetitions of the PUSCH to the second device based on the information. Correspondingly, the second device 202 can also determine 240 the information for scheduling the PDSCH or the PUSCH which is included in the control information. The second device 202 may likewise determine 250 one or more configurations for transmitting the one or more repetitions of the PDSCH to the first device 201 or receiving the one or more repetitions of the PUSCH from the first device 201 based on the information. It is to be understood that, the second device 202 can determine the one or more configurations in a same way as the first device 201.

As shown in FIG. 2, the second device 202 may communicate 260 the repetitions with the first device 201 based on the determined one or more configurations. For example, the second device 202 may transmit the repetitions of the PDSCH to the first device 201 based on the determined one or more configurations. Correspondingly, the first device 201 may receive the repetitions of the PDSCH from the second device 202 based on the determined one or more configurations. Alternatively, the first device 201 may transmit the repetitions of the PUSCH to the second device 202 based on the determined one or more configurations. Correspondingly, the second device 202 may receive the repetitions of the PUSCH from the first device 201 based on the determined one or more configurations.

In the following, some embodiments of the present disclosure will be described with reference to PDSCH. It is to be understood that this is merely for the purpose of illustration, without suggesting any limitation to the scope of the present disclosure. Embodiments of the present disclosure can also be applicable to PUSCH.

In some embodiments, the number of transmission occasions may depend on at least one of TCI field present or not in DCI, tci-PresentInDCI is set as ‘enabled’ or not configured, tci-PresentInDCI-ForFormat1_2 is configured or not, the offset between the reception of the DL DCI and the corresponding PDSCH is less than or no less than (larger than or equal to) the threshold timeDurationForQCL, indicated DMRS port(s) within one CDM group or not in the DCI field “Antenna Port(s)”, the number of TCI states indicated by the DCI field ‘Transmission Configuration Indication’ of the scheduling DCI. In some embodiments, the number of transmission occasions may be different when TCI field is present in DCI and TCI field is not present in DCI. For example, when TCI field present in DCI, the number of transmission occasions is X (where X is positive integer, and X is at least one of {1,2,3,4,5,6,7,8,16}), and when TCI field is not present in DCI, the number of transmission occasions is Y (where Y is positive integer, and Y is at least one of {1,2,3,4,5,6,7,8,16}), and X Y For example, XSY In some embodiments, the number of transmission occasions may be different if tci-PresentInDCI is set as ‘enabled’ and tci-PresentInDCI is not configured. For example, when tci-PresentInDCI is set as ‘enabled’, the number of transmission occasions is X (where X is positive integer, and Xis at least one of {1,2,3,4,5,6,7,8,16}), and when tci-PresentInDCI is not configured, the number of transmission occasions is Y (where Y is positive integer, and Y is at least one of {1,2,3,4,5,6,7,8,16}), and X Y For example, XSY In some embodiments, the number of transmission occasions may be different if tci-PresentInDCI-ForFormat1_2 is configured and tci-PresentInDCI-ForFormat1_2 is not configured. For example, when tci-PresentInDCI-ForFormat1_2 is configured, the number of transmission occasions is X (where X is positive integer, and X is at least one of {1,2,3,4,5,6,7,8,16}), and when tci-PresentInDCI-ForFormat1_2 is not configured, the number of transmission occasions is Y (where Y is positive integer, and Y is at least one of {1,2,3,4,5,6,7,8,16}), and X≠Y For example, X≤Y. In some embodiments, the number of transmission occasions may be different when the offset between the reception of the DL DCI and the corresponding PDSCH is larger than or equal to the threshold timeDurationForQCL and when the offset between the reception of the DL DCI and the corresponding PDSCH is less than the threshold timeDurationForQCL. For example, when the offset between the reception of the DL DCI and the corresponding PDSCH is less than the threshold timeDurationForQCL, the number of transmission occasions is X (where X is positive integer, and X is at least one of {1,2,3,4,5,6,7,8,16}), and when the offset between the reception of the DL DCI and the corresponding PDSCH is larger than or equal to the threshold timeDurationForQCL, the number of transmission occasions is Y (where Y is positive integer, and Y is at least one of {1,2,3,4,5,6,7,8,16}), and X≠Y For example, X≤Y In some embodiments, the number of transmission occasions may be different when the number of TCI states indicated by the DCI field ‘Transmission Configuration Indication’ of the scheduling DCI are different. For example, when the number of TCI states indicated is 1, the number of transmission occasions is X (where X is positive integer, and X is at least one of {1,2,3,4,5,6,7,8,16}), and when the number of TCI states indicated is 2, the number of transmission occasions is Y (where Y is positive integer, and Y is at least one of {1,2,3,4,5,6,7,8,16}), and X≠Y For example, X≤Y For example, the number of transmission occasions may be applied for a UE configured with scheme 2a or scheme 2b or scheme 3 or scheme 4 or for a UE is configured by the higher layer parameter RepSchemeEnabler set to “TDMSchemeA” or “FDMSchemeA” or “FDMSchemeB” or a UE configured by the higher layer parameter PDSCH-config that indicates at least one entry in pdsch-TimeDomainAllocationList contain RepNumR16 in PDSCH-TimeDomainResourceAllocation and/or indicated DMRS port(s) within one CDM group in the DCI field “Antenna Port(s)”.

In some embodiments, if a UE is configured with scheme 3 or a UE is configured by the higher layer parameter RepSchemeEnabler set to “TDMSchemeA” and/or indicated DMRS port(s) within one CDM group in the DCI field “Antenna Port(s)”. In some embodiments, the number of PDSCH transmission occasions is derived by the number of TCI states indicated by the DCI field ‘Transmission Configuration Indication’ of the scheduling DCI if the offset between the reception of the DL DCI and the corresponding PDSCH is larger than or equal to the threshold timeDurationForQCL. In some embodiments, the number of PDSCH transmission occasions is 2, if at least one TCI codepoint is mapped to or indicates two TCI states (for example, two different TCI states) and if the offset between the reception of the DL DCI and the corresponding PDSCH is less than the threshold timeDurationForQCL. In some embodiments, the number of PDSCH transmission occasions is 1, if no TCI codepoint is mapped to or indicates two different TCI states. In some embodiments, the number of PDSCH transmission occasions is 1, if no TCI codepoint is mapped to or indicates two different TCI states and if the offset between the reception of the DL DCI and the corresponding PDSCH is less than the threshold timeDurationForQCL. In some embodiments, the number of PDSCH transmission occasions is 1, if the offset between the reception of the DL DCI and the corresponding PDSCH is less than the threshold timeDurationForQCL. In some embodiments, the number of PDSCH transmission occasions is 2, if two TCI states are indicated by the DCI field ‘Transmission Configuration Indication’ and if the offset between the reception of the DL DCI and the corresponding PDSCH is less than the threshold timeDurationForQCL. In some embodiments, the number of PDSCH transmission occasions is 1, if one TCI state is indicated by the DCI field ‘Transmission Configuration Indication’ and if the offset between the reception of the DL DCI and the corresponding PDSCH is less than the threshold timeDurationForQCL.

In some embodiments, when a UE is configured by the higher layer parameter RepSchemeEnabler set to ‘TDMSchemeA’ and indicated DM-RS port(s) within one CDM group in the DCI field “Antenna Port(s)”, the number of PDSCH transmission occasions is derived by the number of TCI states indicated by the DCI field ‘Transmission Configuration Indication’ of the scheduling DCI if the offset between the reception of the DL DCI and the corresponding PDSCH is larger than or equal to the threshold timeDurationForQCL, and the number of PDSCH transmission occasions is 2 if at least one TCI codepoint indicates two TCI states and if the offset between the reception of the DL DCI and the corresponding PDSCH is less than the threshold timeDurationForQCL, and the number of PDSCH transmission occasions is 1 otherwise.

In some embodiments, if a UE is configured with scheme 3 or a UE is configured by the higher layer parameter RepSchemeEnabler set to “TDMSchemeA” and/or indicated DMRS port(s) within one CDM group in the DCI field “Antenna Port(s)”. In some embodiments, the number of PDSCH transmission occasions may be 1 if TCI field is not present in DCI or if tci-PresentInDCI is not configured or if tci-PresentInDCI-ForFormat1_2 is not configured. In some embodiments, the number of PDSCH transmission occasions may be 2 if at least one TCI codepoint is mapped to or indicates two TCI states (for example, two different TCI states) and if TCI field is not present in DCI or if tci-PresentInDCI is not configured or if tci-PresentInDCI-ForFormat1_2 is not configured. In some embodiments, the number of PDSCH transmission occasions may be 1 if no TCI codepoint is mapped to or indicates two TCI states (for example, two different TCI states) and if TCI field is not present in DCI or if tci-PresentInDCI is not configured or if tci-PresentInDCI-ForFormat1_2 is not configured. In some embodiments, when a UE is configured by the higher layer parameter RepSchemeEnabler set to ‘TDMSchemeA’ and indicated DM-RS port(s) within one CDM group in the DCI field “Antenna Port(s)”, the number of PDSCH transmission occasions is derived by the number of TCI states indicated by the DCI field ‘Transmission Configuration Indication’ of the scheduling DCI if tci-PresentInDCI is set to ‘enabled’ or tci-PresentInDCI-ForFormat1_2 is configured.

In some embodiments, when a UE is configured by the higher layer parameter RepSchemeEnabler set to ‘TDMSchemeA’ and indicated DM-RS port(s) within one CDM group in the DCI field “Antenna Port(s)”, the number of PDSCH transmission occasions is derived by the number of TCI states indicated by the DCI field ‘Transmission Configuration Indication’ of the scheduling DCI if tci-PresentInDCI is set to ‘enabled’ or tci-PresentInDCI-ForFormat1_2 is configured, and the number of PDSCH transmission occasions is 1 otherwise.

In some embodiments, when a UE is configured by the higher layer parameter RepSchemeEnabler set to ‘TDMSchemeA’ and indicated DM-RS port(s) within one CDM group in the DCI field “Antenna Port(s)”, the number of PDSCH transmission occasions is derived by the number of TCI states indicated by the DCI field ‘Transmission Configuration Indication’ of the scheduling DCI if tci-PresentInDCI is set to ‘enabled’, and the number of PDSCH transmission occasions is 2 if at least one TCI codepoint is mapped to or indicates two TCI states (for example, two different TCI states) and if tci-PresentInDCI is not configured, and the number of PDSCH transmission occasions is 1 otherwise.

In some embodiments, when a UE is with scheme 2a or scheme 2b or scheme 3 or scheme 4 or a UE is configured by the higher layer parameter RepSchemeEnabler set to “TDMSchemeA” or “FDMSchemeA” or “FDMSchemeB” or a UE configured by the higher layer parameter PDSCH-config that indicates at least one entry in pdsch-TimeDomainAllocationList contain RepNumR16 in PDSCH-TimeDomainResourceAllocation and/or indicated DM-RS port(s) within one CDM group in the DCI field “Antenna Port(s)”, the UE assumes or expects or is expected TCI field is present in DCI (for example, DCI format 1_1 or DCI format 1_2). Or alternatively, the UE assumes or expects or is expected tci-PresentInDCI is set to “enabled” or tci-PresentInDCI-ForFormat1_2 is configured. Or alternatively, the UE assumes or expects or is expected at least one TCI codepoint is mapped to or indicates two TCI states (for example, two different TCI states). Or alternatively, the UE assumes or expects or is expected the offset between the reception of the DL DCI and the corresponding PDSCH is larger than or equal to the threshold timeDurationForQCL. Or alternatively, the UE does not expect TCI field is not present in DCI (for example, DCI format 1_1 or DCI format 1_2). Or alternatively, the UE does not expect tci-PresentInDCI is not configured or tci-PresentInDCI-ForFormat1_2 is not configured. Or alternatively, the UE does not expect no TCI codepoint is mapped to or indicates two TCI states (for example, two different TCI states). Or alternatively, the UE does not expect the offset between the reception of the DL DCI and the corresponding PDSCH is less than the threshold timeDurationForQCL.

In some embodiments, in the present disclosure, the terms “TCI field is not present in DCI”, “tci-PresentInDCI is not configured”, “tci-PresentInDCI-ForFormat1_2 is not configured” and “Condition 1-1” can be used interchangeably, and in the following Condition 1-1 is used to describe for convenience. The terms “TCI field is present in DCI”, “tci-PresentInDCI is configured”, “tci-PresentInDCI is set to ‘enabled’ ”, “tci-PresentInDCI-ForFormat1_2 is configured” and “Condition 1-2” can be used interchangeably, and in the following Condition 1-2 is used to describe for convenience. The terms “no TCI codepoint is mapped to two TCI states”, “no TCI codepoint indicates two TCI states”, “no TCI codepoint is mapped to two different TCI states”, “no TCI codepoint indicates two different TCI states”, “all the TCI codepoints are mapped to a single TCI state”, “all the TCI codepoints indicate a single TCI state” and “Condition 2-1” can be used interchangeably, and in the following Condition 2-1 is used to describe for convenience. The terms “at least one TCI codepoint is mapped to two TCI states”, “at least one TCI codepoint indicates two TCI states”, “at least one TCI codepoint is mapped to two different TCI states”, “at least one TCI codepoint indicates two different TCI states”, and “Condition 2-2” can be used interchangeably, and in the following Condition 2-2 is used to describe for convenience. The terms “the offset between the reception of the DL DCI and the corresponding PDSCH is less than the threshold timeDurationForQCL”, “the offset between the reception of the DL DCI and the corresponding first PDSCH repetition is less than the threshold timeDurationForQCL”, “the offset between the last symbol of the reception of the DL DCI and the first symbol of the corresponding PDSCH is less than the threshold timeDurationForQCL”, “the offset between the last symbol of the reception of the DL DCI and the first symbol of the corresponding first PDSCH repetition is less than the threshold timeDurationForQCL”, “the offset between the last symbol of the reception of the DL DCI and the first symbol of the corresponding last PDSCH repetition is less than the threshold timeDurationForQCL” and “Condition 3-1” can be used interchangeably, and in the following Condition 3-1 is used to describe for convenience. The terms “the offset between the reception of the DL DCI and the corresponding PDSCH is larger than or equal to the threshold timeDurationForQCL”, “the offset between the last symbol of the reception of the DL DCI and the first symbol of the corresponding PDSCH is larger than or equal to the threshold timeDurationForQCL”, “the offset between the last symbol of the reception of the DL DCI and the first symbol of the corresponding first PDSCH repetition is less than the threshold timeDurationForQCL”, “the offset between the last symbol of the reception of the DL DCI and the first symbol of the corresponding last PDSCH repetition is less than the threshold timeDurationForQCL”, “the offset between the reception of the DL DCI and the corresponding PDSCH is equal to or greater than the threshold timeDurationForQCL”and “Condition 3-2” can be used interchangeably, and in the following Condition 3-2 is used to describe for convenience. The terms “the offset between the reception of the DL DCI and all of the corresponding PDSCH transmission occasion(s) is less than the threshold timeDurationForQCL”, “the offset between the last symbol of the reception of the DL DCI and the first symbol of all of the corresponding PDSCH transmission occasions is less than the threshold timeDurationForQCL”, “the offset between the reception of the DL DCI and both of the two transmission occasions is less than the threshold timeDurationForQCL”, “the offset between the last symbol of the reception of the DL DCI and the first symbol of both of the two transmission occasions is less than the threshold timeDurationForQCL”and “Condition 3-1-1” can be used interchangeably, and in the following Condition 3-1-1 is used to describe for convenience. For example, as shown in FIG. 5.

In some embodiments, when a UE configured with scheme 3 or scheme 4 or for a UE is configured by the higher layer parameter RepSchemeEnabler set to “TDMSchemeA” or a UE configured by the higher layer parameter PDSCH-config that indicates at least one entry in pdsch-TimeDomainAllocationList contain RepNumR16 in PDSCH-TimeDomainResourceAllocation and/or indicated DMRS port(s) within one CDM group in the DCI field “Antenna Port(s)”. The number of transmission occasions may be P, where P is positive integer and P may be at least one of {1,2,3,4,5,6,7,8,16}. In some embodiments, if 2<P≤16, the UE may be configured with CycMapping or SeqMapping in RepTCIMapping in higher layer signaling. For example, if UE is not configured with either CycMapping or SeqMapping, CycMapping is assumed. For another example, if UE is not configured with either CycMapping or SeqMapping, SeqMapping is assumed. In some embodiments, there may be Q transmission occasions, where Q is positive integer, and 1≤Q<P. And the offset between the reception of the DL DCI and all of the Q transmission occasions are less than the threshold timeDurationForQCL. The terms “the offset between the reception of the DL DCI and the corresponding Q PDSCH transmission occasion(s) is less than the threshold timeDurationForQCL”, “the offset between the reception of the DL DCI and a subset of all of the corresponding PDSCH transmission occasion(s) is less than the threshold timeDurationForQCL”, “the offset between the last symbol of the reception of the DL DCI and the first symbol of a subset of all of the corresponding PDSCH transmission occasions is less than the threshold timeDurationForQCL”, “the offset between the last symbol of the reception of the DL DCI and the first symbol of all of the corresponding Q PDSCH transmission occasions is less than the threshold timeDurationForQCL”, “the offset between the reception of the DL DCI and the first transmission occasion is less than the threshold timeDurationForQCL and the offset between the reception of the DL DCI and the second transmission occasion is larger than or equal to the threshold timeDurationForQCL”, “the offset between the last symbol of the reception of the DL DCI and the first symbol of the first transmission occasion is less than the threshold timeDurationForQCL and the offset between the last symbol of the reception of the DL DCI and the first symbol of the second transmission occasion is larger than or equal to the threshold timeDurationForQCL” and “Condition 3-1-2” can be used interchangeably, and in the following Condition 3-1-2 is used to describe for convenience. For example, as shown in FIG. 6 or FIG. 7.

In some embodiments, in case of Condition 1-1 and Condition 3-1, the UE may assume that the DM-RS ports of PDSCH of a serving cell are quasi co-located with the RS(s) with respect to the QCL parameter(s) used for PDCCH quasi co-location indication of the CORESET associated with a monitored search space with the lowest controlResourceSetld in the latest slot in which one or more CORESETs within the active BWP of the serving cell are monitored by the UE.

In some embodiments, in the present disclosure, the terms “the RS(s) with respect to the QCL parameter(s) used for PDCCH quasi co-location indication of the CORESET associated with a monitored search space with the lowest controlResourceSetld in the latest slot in which one or more CORESETs within the active BWP of the serving cell are monitored by the UE”, “the RS(s) with respect to the QCL parameter(s) used for PDCCH quasi co-location indication of the CORESET associated with a monitored search space with the lowest CORESET-ID among CORESETs, which are configured with the same value of CORESETPoolIndex as the PDCCH scheduling that PDSCH, in the latest slot in which one or more CORESETs associated with the same value of CORESETPoolIndex as the PDCCH scheduling that PDSCH within the active BWP of the serving cell are monitored by the UE”, and “default beam-1” can be used interchangeably, and in the following “default beam-1” is used to describe for convenience. The terms “the RS(s) with respect to the QCL parameter(s) associated with the TCI states corresponding to the lowest codepoint among the TCI codepoints containing two different TCI states” and “default beam-2” can be used interchangeably, and in the following “default beam-2” is used to describe for convenience. The terms “one transmission occasion” and “UE is expected to receive one transmission occasion” can be used interchangeably. The terms “two transmission occasion” and “UE is expected to receive two transmission occasions” can be used interchangeably. The terms “the number of transmission occasion(s)” and “the number of transmission occasion(s) UE is expected to receive” can be used interchangeably. The terms “the UE may assume that the DMRS port(s) of the transmission occasion(s) are quasi co-located with”, “the DMRS port(s) of the transmission occasion(s) are quasi co-located with”, “QCL parameter(s)/configuration is applied to the transmission occasion(s)” and “TCI state is applied to the transmission occasion(s)” can be used interchangeably. The terms “the UE may assume that the DMRS port(s) of the transmission occasion(s) are quasi co-located with default beam-1”, “the DMRS port(s) of the transmission occasion(s) are quasi co-located with default beam-1”, “default beam-1 is applied to the transmission occasion(s)” can be used interchangeably. The terms “the UE may assume that the DMRS port(s) of the transmission occasion(s) are quasi co-located with one or two TCI states of default beam-2”, “the DMRS port(s) of the transmission occasion(s) are quasi co-located with one or two TCI states of default beam-2”, “one or two TCI states of default beam-2 is applied to the transmission occasion(s)”. The terms “the UE may assume that the DMRS port(s) of the transmission occasion(s) are quasi co-located with the first TCI state of default beam-2”, “the DMRS port(s) of the transmission occasion(s) are quasi co-located with the first TCI state of default beam-2”, “the first TCI state of default beam-2 is applied to the transmission occasion(s)” can be used interchangeably. The terms “the UE may assume that the DMRS port(s) of the transmission occasion(s) are quasi co-located with the second TCI state of default beam-2”, “the DMRS port(s) of the transmission occasion(s) are quasi co-located with the second TCI state of default beam-2”, “the second TCI state of default beam-2 is applied to the transmission occasion(s)” can be used interchangeably.

In some embodiments, if a UE is configured with scheme 3 or a UE is configured by the higher layer parameter RepSchemeEnabler set to “TDMSchemeA” and/or indicated DMRS port(s) within one CDM group in the DCI field “Antenna Port(s)”.

In some embodiments, in case of Condition 1-1 and Condition 2-1 and Condition 3-2 or in case of Condition 1-1 and Condition 2-2 and Condition 3-2 or in case of Condition 1-2 and Condition 2-1 and Condition 3-2 or in case of Condition 1-1 and Condition 2-1 and Condition 3-1 or in case of Condition 1-1 and Condition 2-1 and Condition 3-1-1 or in case of Condition 1-1 and Condition 2-1 and Condition 3-1-2 or in case of Condition 1-1 and Condition 2-2 and Condition 3-1 or in case of Condition 1-1 and Condition 2-2 and Condition 3-1-1 or in case of Condition 1-1 and Condition 2-2 and Condition 3-1-2 or in case of Condition 1-2 and Condition 2-1 and Condition 3-1 or in case of Condition 1-2 and Condition 2-1 and Condition 3-1-1 or in case of Condition 1-2 and Condition 2-1 and Condition 3-1-2 or in case of Condition 1-2 and Condition 2-2 and Condition 3-1 or in case of Condition 1-2 and Condition 2-2 and Condition 3-1-1 or in case of Condition 1-2 and Condition 2-2 and Condition 3-1-2. In some embodiments, the number of transmission occasions is 1, and default beam-1 is applied to the transmission occasion. In some embodiments, the number of transmission occasions is 2. And default beam-1 is applied to both of the two transmission occasions.

In some embodiments, in case of Condition 1-1 and Condition 2-2 and Condition 3-2 or in case of Condition 1-1 and Condition 2-2 and Condition 3-1 or in case of Condition 1-1 and Condition 2-2 and Condition 3-1-1 or in case of Condition 1-1 and Condition 2-2 and Condition 3-1-2 or in case of Condition 1-2 and Condition 2-2 and Condition 3-1 or in case of Condition 1-2 and Condition 2-2 and Condition 3-1-1 or in case of Condition 1-2 and Condition 2-2 and Condition 3-1-2. In some embodiments, the number of transmission occasions is 2. And the first TCI state of default beam-2 is applied to the first transmission occasion, and the second TCI of default beam-2 is applied to the second transmission occasion. In some embodiments, the number of transmission occasions is 1. And the first or second TCI state of default beam-2 is applied to the transmission occasion. In some embodiments, the number of transmission occasions is 2. And the first or second TCI state of default beam-2 is applied to both the two transmission occasions.

In some embodiments, in case of Condition 1-2 and Condition 2-1 and Condition 3-2. In some embodiments, the number of transmission occasions is 2. And the one indicated TCI state by the DCI field ‘Transmission Configuration Indication’ is applied to the two transmission occasions. In some embodiments, the number of transmission occasions is 1. And the one indicated TCI state by the DCI field ‘Transmission Configuration Indication’ is applied to the transmission occasion.

In some embodiments, in case of Condition 1-2 and Condition 2-2 and Condition 3-1 or in case of Condition 1-2 and Condition 2-2 and Condition 3-1-1 or in case of Condition 1-2 and Condition 2-2 and Condition 3-1-2. In some embodiments, the number of transmission occasions is derived by the number of TCI states indicated by the DCI field ‘Transmission Configuration Indication’ of the scheduling DCI. And one or two TCI states of default beam-2 is applied to the transmission occasion(s). For example, if the number of indicated TCI states is 1, the number of transmission occasions is 1, and the first or second TCI state of default beam-2 is applied to the transmission occasion. For another example, if the number of indicated TCI states is 2, the number of transmission occasions is 2, and the first TCI state of default beam-2 is applied to the first transmission occasion, and the second TCI state of default beam-2 is applied to the second transmission occasion.

In some embodiments, in case of Condition 1-2 and Condition 2-1 and Condition 3-1-2. In some embodiments, the number of transmission occasions is 2, and default beam-1 is applied to the first transmission occasion, and the TCI state indicated by the DCI field ‘Transmission Configuration Indication’ of the scheduling DCI is applied to the second transmission occasion. In some embodiments, the number of transmission occasion is 1. And the transmission occasion is the second transmission, or in other words, the transmission occasion satisfies the offset between the reception of the DL DCI and the transmission occasion is larger than or equal to the threshold timeDurationForQCL. In some embodiments, the TCI state indicated by the DCI field ‘Transmission Configuration Indication’ of the scheduling DCI is applied to the transmission occasion. In some embodiments, default beam-1 is applied to the transmission occasion. In some embodiments, in case of Condition 1-2 and Condition 2-2 and Condition 3-1-2. In some embodiments, the number of transmission occasions is 2, and the first TCI state or the second TCI state of default beam-2 is applied to the first transmission occasion. In some embodiments, the one indicated TCI state is applied to the second transmission occasion if the number of TCI states indicated by the DCI field ‘Transmission Configuration Indication’ of the scheduling DCI is 1. In some embodiments, the first or second indicated TCI state is applied to the second transmission occasion if the number of TCI states indicated by the DCI field ‘Transmission Configuration Indication’ of the scheduling DCI is 2. In some embodiments, the number of transmission occasions is derived by the number of TCI states indicated by the DCI field ‘Transmission Configuration Indication’ of the scheduling DCI. For example, if the number of indicated TCI states is 1, the number of transmission occasions is 1, and the first or second TCI state of default beam-2 is applied to the transmission occasion. For another example, if the number of TCI states indicated is 2, the number of transmission occasions is 2, and the first or second TCI state of default beam-2 is applied to the first transmission occasion, and the first or second TCI state of indicated TCI states is applied to the second transmission occasion. In some embodiments, the number of transmission occasions is 1. And the transmission occasion is the second transmission, or in other words, the transmission occasion satisfies the offset between the reception of the DL DCI and the transmission occasion is larger than or equal to the threshold timeDurationForQCL. And for example, if the number of TCI states indicated by the DCI field ‘Transmission Configuration Indication’ of the scheduling DCI is 1, the indicated TCI state is applied to the transmission occasion. For another example, if the number of TCI states indicated by the DCI field ‘Transmission Configuration Indication’ of the scheduling DCI is 2, the first or second indicated TCI state is applied to the transmission occasion.

In some embodiments, if a UE is configured with scheme 4 or a UE configured by the higher layer parameter PDSCH-config that indicates at least one entry in pdsch-TimeDomainAllocationList contain RepNumR16 in PDSCH-TimeDomainResourceAllocation and/or indicated DMRS port(s) within one CDM group in the DCI field “Antenna Port(s)”. In some embodiments, the UE is indicated with an entry in pdsch-TimeDomainAllocationList contain RepNumR16 in the DCI. The number of transmission occasions may be P, where P is positive integer and P may be at least one of {1,2,3,4,5,6,7,8,16}. In some embodiments, if 2<P≤16, the UE may be configured with CycMapping or SeqMapping in RepTClMapping in higher layer signaling. For example, if UE is not configured with either CycMapping or SeqMapping, CycMapping is assumed. For another example, if UE is not configured with either CycMapping or SeqMapping, SeqMapping is assumed.

In some embodiments, if 2<P≤16. In some embodiments, there may be Q transmission occasions, where Q is positive integer, and 1≤Q<P. And the offset between the reception of the DL DCI and all of the Q transmission occasions are less than the threshold timeDurationForQCL. For example, the number of transmission occasions which satisfy the offset between the reception of the DL DCI and the transmission occasion is larger than or equal to the threshold timeDurationForQCL is P-Q.

In some embodiments, the total number of available and/or applied TCI states or total number of available and/or applied sets of QCL parameter(s) applied to the P transmission occasion(s) may be different in different conditions/cases. In some embodiments, in case of Condition 1-1 and Condition 2-1, the total number of available and/or applied TCI states or total number of available and/or applied sets of QCL parameter(s) may be Np, for example, N_{P}=1. In some embodiments, in case of Condition 1-1 and Condition 2-2, the total number of available and/or applied TCI states or total number of available and/or applied sets of QCL parameter(s) may be Np, for example, N_{P}=1 or 2. In some embodiments, in case of Condition 1-2 and Condition 2-1 and Condition 3-1 or in case of Condition 1-2 and Condition 2-1 and Condition 3-1-1, the total number of available and/or applied TCI states or total number of available and/or applied sets of QCL parameter(s) may be Np, for example, N_{P}=1. In some embodiments, in case of Condition 1-2 and Condition 2-1 and Condition 3-1-2, the total number of available and/or applied TCI states or total number of available and/or applied sets of QCL parameter(s) may be N_{P}, for example, N_{P}=1 or 2. In some embodiments, in case of Condition 1-2 and Condition 2-2 and Condition 3-1-2, the total number of available and/or applied TCI states or total number of available and/or applied sets of QCL parameter(s) may be N_{P}, for example, N_{P}=1 or 2 or 3 or 4.

In some embodiments, for the Q transmission occasions, the total number of applied TCI states or total number of applied sets of QCL parameter(s) may be K_{Q}, for example, K_{Q}=1 or 2. For example, in case of Condition 1-1 and/or Condition 2-1, the total number of applied TCI states or total number of applied sets of QCL parameter(s) for the Q transmission occasions may be K_{Q}, for example, K_{Q}=1. For another example, in case of Condition 1-1 and Condition 2-2 or in case of Condition 1-2 and Condition 2-2 and Condition 3-1, the total number of applied TCI states or total number of applied sets of QCL parameter(s) for the Q transmission occasions may be K_{Q}, for example, K_{Q}=1 or 2. In some embodiments, for the Q transmission occasions, the number of available TCI states or number of available sets of QCL parameter(s) may be N_{Q}, for example, N_{Q}=1 or 2. In some embodiments, for the P-Q transmission occasions, the total number of applied TCI states or total number of applied sets of QCL parameter(s) may be K_{R}, for example, K_{R}=1 or 2. In some embodiments, for the P-Q transmission occasions, the available number of TCI states or available number of sets of QCL parameter(s) may be N_{R}, for example, N_{R}=1 or 2 or 3 or 4. In some embodiments, the N_{Q} available TCI states or the N_{Q} available sets of QCL parameter(s) may be same or a subset of the N_{R} available TCI states or the N_{R} available sets of QCL parameter(s). In some embodiments, the K_{Q} applied TCI states or the K_{Q} applied sets of QCL parameter(s) may be same or a subset of the K_{R} applied TCI states or the KR applied sets of QCL parameter(s).

In some embodiments, if the number of available and/or applied TCI states or available and/or applied set of QCL parameter(s) is 1. For example, when N_{P}=1. The one available and/or applied TCI state or the one available and/or applied set of QCL parameter(s) is applied to the transmission occasion(s). In this case, the one TCI state or one (set of) QCL parameter(s) is represented by “TCI state A0”, and in the following, “TCI state A0” is used to describe for convenience.

In some embodiments, if the number of available and/or applied TCI states or available and/or applied set of QCL parameter(s) is 2. For example, when N_{P}=2. In this case, the first TCI state or first (set of) QCL parameter(s) of the Np TCI states or N_{P} (sets of) QCL parameter(s) is represented by “TCI state A”, and in the following, “TCI state A” is used to describe for convenience. In this case, the second TCI state or second (set of) QCL parameter(s) of the N_{P} TCI states or N_{P} (sets of) QCL parameter(s) is represented by “TCI state B”, and in the following, “TCI state B” is used to describe for convenience. In some embodiments, if P=2, “TCI state A” is applied to the first transmission occasion, and the “TCI state B” is applied to the second transmission occasion. In some embodiments, if P>2, and when CycMapping is enabled or assumed, “TCI state A” and “TCI state B” are applied to the first and second transmission occasions, respectively, and the same TCI mapping pattern continues to the remaining. For example, if P=3, “TCI state A” is applied to the third transmission occasion. For another example, “TCI state A” is applied to the odd transmission occasion(s), and “TCI state B” is applied to the even transmission occasion(s). In some embodiments, if P>2, and when SeqMapping is enabled or assumed, “TCI state A” is applied to the first and second transmission occasions, and “TCI state B” is applied to the third and/or fourth transmission occasions (for example, the fourth transmission occasion exists), and the same TCI mapping pattern continues to the remaining transmission occasion(s). In some embodiments, “TCI state A” and/or “TCI state B” may be at least one of {default beam-1, first TCI state of default beam-2, second TCI state of default beam-2, indicated one TCI state, the first TCI state of the indicated two TCI states, the second TCI state of the indicated two TCI states}.

In some embodiments, for the Q transmission occasions, if the number of available and/or applied TCI states or available and/or applied set of QCL parameter(s) is 1. For example, when N_{Q}=1. For another example, when K_{Q}=1. The one available and/or applied TCI state or the one available and/or applied set of QCL parameter(s) is applied to the Q transmission occasion(s). In this case, the one TCI state or one (set of) QCL parameter(s) is represented by “TCI state C0”, and in the following, “TCI state C0” is used to describe for convenience.

In some embodiments, for the Q transmission occasions, if the number of available and/or applied TCI states or available and/or applied set of QCL parameter(s) is 2. For example, when N_{Q}=2. For another example, when K_{Q}=2. In this case, the first TCI state or first (set of) QCL parameter(s) of the N_{Q} or K_{Q} TCI states or N_{Q} or K_{Q} (sets of) QCL parameter(s) is represented by “TCI state C”, and in the following, “TCI state C” is used to describe for convenience. In this case, the second TCI state or second (set of) QCL parameter(s) of the N_{Q} or K_{Q} TCI states or N_{Q} or K_{Q} (sets of) QCL parameter(s) is represented by “TCI state D”, and in the following, “TCI state D” is used to describe for convenience. In some embodiments, if Q=1, “TCI state C” is applied to the transmission occasion. In some embodiments, if Q=2, “TCI state C” is applied to the first transmission occasion, and “TCI state D” is applied to the second transmission occasion. In some embodiments, if Q>2, and when CycMapping is enabled or assumed, “TCI state C” and “TCI state D” are applied to the first and second transmission occasions, respectively, and the same TCI mapping pattern continues to the remaining. For example, if Q=3, “TCI state C” is applied to the third transmission occasion. For another example, “TCI state C” is applied to the odd transmission occasion(s), and “TCI state D” is applied to the even transmission occasion(s). In some embodiments, if Q>2, and when SeqMapping is enabled or assumed, “TCI state C” is applied to the first and second transmission occasions, and “TCI state D” is applied to the third and/or fourth transmission occasions (for example, the fourth transmission occasion exists), and the same TCI mapping pattern continues to the remaining transmission occasion(s). In some embodiments, “TCI state C” and/or “TCI state D” for the Q transmission occasions may be at least one of {default beam-1, first TCI state of default beam-2, second TCI state of default beam-2}.

In some embodiments, for the P-Q transmission occasions, if the number of available and/or applied TCI states or available and/or applied set of QCL parameter(s) is 1. For example, when N_{R}=1. For another example, when K_{R}=1. The one available and/or applied TCI state or the one available and/or applied set of QCL parameter(s) is applied to the P-Q transmission occasion(s). In this case, the one TCI state or one (set of) QCL parameter(s) is represented by “TCI state EO”, and in the following, “TCI state E0” is used to describe for convenience.

In some embodiments, for the P-Q transmission occasions, if the number of available and/or applied TCI states or available and/or applied set of QCL parameter(s) is 2. For example, when N_{R}=2. For another example, when K_{R}=2. In this case, the first TCI state or first (set of) QCL parameter(s) of the N_{R} or K_{R} TCI states or N_{R} or K_{R} (sets of) QCL parameter(s) is represented by “TCI state E”, and in the following, “TCI state E” is used to describe for convenience. In this case, the second TCI state or second (set of) QCL parameter(s) of the N_{R} or K_{R} TCI states or N_{R} or K_{R} (sets of) QCL parameter(s) is represented by “TCI state F”, and in the following, “TCI state F” is used to describe for convenience. In some embodiments, if P-Q=1, “TCI state E” is applied to the transmission occasion. In some embodiments, if P-Q=2, “TCI state E” is applied to the first transmission occasion, and “TCI state F” is applied to the second transmission occasion. In some embodiments, if P-Q>2, and when CycMapping is enabled or assumed, “TCI state E” and “TCI state F” are applied to the first and second transmission occasions, respectively, and the same TCI mapping pattern continues to the remaining. For example, if P-Q =3, “TCI state E” is applied to the third transmission occasion. For another example, “TCI state E” is applied to the odd transmission occasion(s), and “TCI state F” is applied to the even transmission occasion(s). In some embodiments, if P-Q>2, and when SeqMapping is enabled or assumed, “TCI state E” is applied to the first and second transmission occasions, and “TCI state F” is applied to the third and/or fourth transmission occasions (for example, the fourth transmission occasion exists), and the same TCI mapping pattern continues to the remaining transmission occasion(s). In some embodiments, “TCI state E” and/or “TCI state F” for the P-Q transmission occasions may be at least one of {default beam-1, first TCI state of default beam-2, second TCI state of default beam-2, indicated one TCI state, the first TCI state of the indicated two TCI states, the second TCI state of the indicated two TCI states}.

In some embodiments, in case of Condition 1-1 and Condition 2-1 and Condition 3-2 or in case of Condition 1-1 and Condition 2-2 and Condition 3-2 or in case of Condition 1-1 and Condition 2-1 and Condition 3-1 or in case of Condition 1-1 and Condition 2-1 and Condition 3-1-1 or in case of Condition 1-1 and Condition 2-1 and Condition 3-1-2 or in case of Condition 1-1 and Condition 2-2 and Condition 3-1 or in case of Condition 1-1 and Condition 2-2 and Condition 3-1-1 or in case of Condition 1-1 and Condition 2-2 and Condition 3-1-2 or in case of Condition 1-2 and Condition 2-1 and Condition 3-1 or in case of Condition 1-2 and Condition 2-1 and Condition 3-1-1 or in case of Condition 1-2 and Condition 2-1 and Condition 3-1-2 or in case of Condition 1-2 and Condition 2-2 and Condition 3-1 or in case of Condition 1-2 and Condition 2-2 and Condition 3-1-1 or in case of Condition 1-2 and Condition 2-2 and Condition 3-1-2. In some embodiments, the number of transmission occasions is 1, and default beam-1 is applied to the transmission occasion. In some embodiments, the number of transmission occasions is P or ceil(P/2) or floor(P/2). And default beam-1 is applied to the transmission occasions.

In some embodiments, in case of Condition 1-1 and Condition 2-2 and Condition 3-2 or in case of Condition 1-1 and Condition 2-2 and Condition 3-1 or in case of Condition 1-1 and Condition 2-2 and Condition 3-1-1 or in case of Condition 1-1 and Condition 2-2 and Condition 3-1-2 or in case of Condition 1-2 and Condition 2-2 and Condition 3-1 or in case of Condition 1-2 and Condition 2-2 and Condition 3-1-1 or in case of Condition 1-2 and Condition 2-2 and Condition 3-1-2. In some embodiments, the number of transmission occasions is T=P or ceil(P/2) or floor(P/2), T is positive integer, and T is at least one of {1,2,3,4,5,6,7,8,16}. In some embodiments, the first TCI state of the default beam-2 is applied as “TCI state A”, and the second TCI state of the default beam-2 is applied as “TCI state B”. In some embodiments, the first and/or second TCI state of default beam-2 is applied as “TCI state A0”. In some embodiments, “TCI state A” or “TCI state A0” may be applied to the T transmission occasions. In some embodiments, “TCI state A” and “TCI state B” may be applied to the T transmission occasions according to some embodiments in the disclosure (For example, embodiments [00111] to embodiments [00120]). In some embodiments, the number of transmission occasions is 1, and “TCI state A” or “TCI state A0” may be applied to the transmission occasion.

In some embodiments, in case of Condition 1-2 and Condition 2-2 and Condition 3-1 or in case of Condition 1-2 and Condition 2-2 and Condition 3-1-1 or in case of Condition 1-2 and Condition 2-2 and Condition 3-1-2. In some embodiments, the number of transmission occasions and/or the number of TCI state(s) and/or the number of (sets of) QCL parameter(s) applied for the transmission occasion(s) depends on the number of TCI states indicated in DCI (for example, the number of TCI states indicated by the DCI field ‘Transmission Configuration Indication’ of the scheduling DCI). In some embodiments, the first TCI state of the default beam-2 is applied as “TCI state A”, and the second TCI state of the default beam-2 is applied as “TCI state B”. In some embodiments, the first and/or second TCI state of default beam-2 is applied as “TCI state A0”. In some embodiments, if the number of TCI states indicated in DCI is 1, the number of transmission occasions is 1, and “TCI state A” or “TCI state A0” is applied to the transmission occasion. In some embodiments, if the number of TCI states indicated in DCI is 2, the number of transmission occasions is P, and same TCI state or same (set of) QCL parameter(s) is applied to the P transmission occasions and “TCI state A” or “TCI state A0” is applied to the P transmission occasions. In some embodiments, if the number of TCI states indicated in DCI is 1, the number of transmission occasions is P, and same TCI state or same (set of) QCL parameter(s) is applied to the P transmission occasions and “TCI state A” or “TCI state A0” is applied to the P transmission occasions. In some embodiments, if the number of TCI states indicated in DCI is 2, the number of transmission occasions is P, “TCI state A” and “TCI state B” is applied to the P transmission occasions according to some embodiments in the disclosure (For example, embodiments [00111] to embodiments [00120]).

In some embodiments, in case of Condition 1-1 and Condition 2-1 and Condition 3-1 or in case of Condition 1-1 and Condition 2-1 and Condition 3-1-2 or in case of Condition 1-1 and Condition 2-2 and Condition 3-1 or in case of Condition 1-1 and Condition 2-2 and Condition 3-1-2 or in case of Condition 1-2 and Condition 2-1 and Condition 3-1 or in case of Condition 1-2 and Condition 2-1 and Condition 3-1-2 or in case of Condition 1-2 and Condition 2-2 and Condition 3-1 or in case of Condition 1-2 and Condition 2-2 and Condition 3-1-2. In some embodiments, default beam-1 is applied as “TCI state C0”. In some embodiments, the number of transmission occasions is 1, and “TCI state C0” is applied to the transmission occasion. In some embodiments, the number of transmission occasions is Q according to some embodiments in the disclosure (For example, the offset between the reception of the DL DCI and the corresponding Q PDSCH transmission occasion(s) is less than the threshold timeDurationForQCL) (For example, embodiments [00111] to embodiments [00120]) , and “TCI state C0” is applied to the Q transmission occasions.

In some embodiments, in case of Condition 1-1 and Condition 2-2 and Condition 3-1 or in case of Condition 1-1 and Condition 2-2 and Condition 3-1-2 or in case of Condition 1-2 and Condition 2-2 and Condition 3-1 or in case of Condition 1-2 and Condition 2-2 and Condition 3-1-2. In some embodiments, the first TCI state of default beam-2 is applied as “TCI state C”, and the second TCI state of default beam-2 is applied as “TCI state D”. In some embodiments, the first or second TCI state of default beam-2 is applied as “TCI state C0”. In some embodiments, the number of transmission occasions is 1, and “TCI state C” or “TCI state C0” is applied to the transmission occasion. In some embodiments, the number of transmission occasions is Q according to some embodiments in the disclosure (For example, the offset between the reception of the DL DCI and the corresponding Q PDSCH transmission occasion(s) is less than the threshold timeDurationForQCL) (For example, embodiments [00111] to embodiments [00120]), and “TCI state C0” or “TCI state C” is applied to the Q transmission occasions. In some embodiments, the number of transmission occasions is Q according to some embodiments in the disclosure (For example, the offset between the reception of the DL DCI and the corresponding Q PDSCH transmission occasion(s) is less than the threshold timeDurationForQCL) (For example, embodiments [00111] to embodiments [00120]), and “TCI state C” and “TCI state D” is applied to the Q transmission occasions according to some embodiments in the disclosure (For example, embodiments [00111] to embodiments) [001020]) .

In some embodiments, in case of Condition 1-2 and Condition 2-1 and Condition 3-1 or in case of Condition 1-2 and Condition 2-1 and Condition 3-1-2. According to some embodiments (For example, embodiments [00111] to embodiments [00120]), and in some embodiments, the number of transmission occasions is P, and there are Q transmission occasions (For example, the offset between the reception of the DL DCI and the corresponding Q PDSCH transmission occasion(s) is less than the threshold timeDurationForQCL), and there are P-Q transmission occasions according to some embodiments in the disclosure (For example, the offset between the reception of the DL DCI and the corresponding P-Q PDSCH transmission occasion(s) is larger than or equal to the threshold timeDurationForQCL). In some embodiments, for the Q transmission occasions, the default beam-1 is applied. In some embodiments, for the P-Q transmission occasions, the default beam-1 is applied as “TCI state E0”. In some embodiments, for the P-Q transmission occasions, the indicated TCI state in DCI (for example, the one TCI state indicated by the DCI field ‘Transmission Configuration Indication’ of the scheduling DCI) is applied as “TCI state E0”. In some embodiments, for the P-Q transmission occasions, the default beam-1 is applied as “TCI state E” and the indicated TCI state in DCI (for example, the one TCI state indicated by the DCI field ‘Transmission Configuration Indication’ of the scheduling DCI) is applied as “TCI state F”. In some embodiments, for the P-Q transmission occasions, the default beam-1 is applied as “TCI state F” and the indicated TCI state in DCI (for example, the one TCI state indicated by the DCI field ‘Transmission Configuration Indication’ of the scheduling DCI) is applied as “TCI state E”. In some embodiments, “TCI state E0” or “TCI state E” is applied for the P-Q transmission occasions according to some embodiments in the disclosure (For example, embodiments

to embodiments [00120]). In some embodiments, “TCI state E” and “TCI state F” is applied for the P-Q transmission occasions according to some embodiments in the disclosure (For example, embodiments [00111] to embodiments [00120]).

In some embodiments, in case of Condition 1-2 and Condition 2-2 and Condition 3-1 or in case of Condition 1-2 and Condition 2-2 and Condition 3-1-2. According to some embodiments (For example, embodiments [00111] to embodiments [00120]), and in some embodiments, the number of transmission occasions is P, and there are Q transmission occasions (For example, the offset between the reception of the DL DCI and the corresponding Q PDSCH transmission occasion(s) is less than the threshold timeDurationForQCL), and there are P-Q transmission occasions according to some embodiments in the disclosure (For example, the offset between the reception of the DL DCI and the corresponding P-Q PDSCH transmission occasion(s) is larger than or equal to the threshold timeDurationForQCL). In some embodiments, the number of transmission occasions is Q (For example, the offset between the reception of the DL DCI and the corresponding Q PDSCH transmission occasion(s) is less than the threshold timeDurationForQCL). In some embodiments, the number of transmission occasions is P-Q transmission occasions according to some embodiments in the disclosure (For example, the offset between the reception of the DL DCI and the corresponding P-Q PDSCH transmission occasion(s) is larger than or equal to the threshold timeDurationForQCL). In some embodiments, for the Q transmission occasions, the first or second TCI state of default beam-2 is applied as “TCI state C0”. In some embodiments, for the Q transmission occasions, the first TCI state of default beam-2 is applied as “TCI state C”, and the second TCI state of default beam-2 is applied as “TCI state D”. In some embodiments, “TCI state C0” or “TCI state C” is applied to the Q transmission occasions. In some embodiments, “TCI state C” and “TCI state D” are applied to the Q transmission occasions according to some embodiments in the disclosure (For example, embodiments [00111] to embodiments)

In some embodiments, there is one or two TCI states indicated in DCI (for example, the one TCI state indicated by the DCI field ‘Transmission Configuration Indication’ of the scheduling DCI). In some embodiments, for P-Q transmission occasions, the first TCI state of default beam-2 or the second TCI state of default beam-2 or the indicated one TCI state or the first TCI state of the indicated two TCI states or the second TCI state of the indicated two TCI states is applied as “TCI state E0” or “TCI state E”, and/or the first TCI state of default beam-2 or the second TCI state of default beam-2 or the indicated one TCI state or the first TCI state of the indicated two TCI states or the second TCI state of the indicated two TCI states is applied as “TCI state F”. In some embodiments, “TCI state E0” or “TCI state E” is applied for the P-Q transmission occasions. In some embodiments, “TCI state E” and “TCI state F” is applied for the P-Q transmission occasions according to some embodiments in the disclosure (For example, embodiments

to embodiments [00120]). In some embodiments, the number of transmission occasions and/or the number of TCI state(s) and/or the number of (sets of) QCL parameter(s) applied for the transmission occasion(s) depends on the number of TCI states indicated in DCI (for example, the number of TCI states indicated by the DCI field ‘Transmission Configuration Indication’ of the scheduling DCI). In some embodiments, if the number of TCI states indicated in DCI is 1, the number of transmission occasions is 1 or Q, and “TCI state C” or “TCI state C0” is applied to the transmission occasion(s). In some embodiments, if the number of TCI states indicated in DCI is 2, the number of transmission occasions is Q or P, and “TCI state C” or “TCI state C0” is applied to the transmission occasion(s). In some embodiments, if the number of TCI states indicated in DCI is 1, the number of transmission occasions is Q or P, and “TCI state C” or “TCI state C0” is applied to the transmission occasions. In some embodiments, if the number of TCI states indicated in DCI is 2, the number of transmission occasions is Q or P, “TCI state C” and “TCI state D” is applied to the transmission occasions according to some embodiments in the disclosure (For example, embodiments [00111] to embodiments [00120]). In some embodiments, if the number of TCI states indicated in DCI is 1, the number of transmission occasions is 1, and “TCI state E” or “TCI state E0” is applied to the transmission occasion. In some embodiments, if the number of TCI states indicated in DCI is 2, the number of transmission occasions is P-Q, and “TCI state E” or “TCI state E0” is applied to the transmission occasion(s). In some embodiments, if the number of TCI states indicated in DCI is 1, the number of transmission occasions is P-Q, and “TCI state E” or “TCI state E0” is applied to the transmission occasions. In some embodiments, if the number of TCI states indicated in DCI is 2, the number of transmission occasions is P-Q, “TCI state E” and “TCI state F” is applied to the transmission occasions according to some embodiments in the disclosure (For example, embodiments [00111] to embodiments [00120]).

In some embodiments, when a UE is with scheme 2a or scheme 2b or a UE is configured by the higher layer parameter RepSchemeEnabler set to “FDMSchemeA” or “FDMSchemeB” and/or indicated DM-RS port(s) within one CDM group in the DCI field “Antenna Port(s)”.

In some embodiments, in case of Condition 1-1 and Condition 2-1 and Condition 3-2 or in case of Condition 1-1 and Condition 2-2 and Condition 3-2 or in case of Condition 1-2 and Condition 2-1 and Condition 3-2 or in case of Condition 1-1 and Condition 2-1 and Condition 3-1 or in case of Condition 1-1 and Condition 2-2 and Condition 3-1 or in case of Condition 1-2 and Condition 2-1 and Condition 3-1 in case of Condition 1-2 and Condition 2-2 and Condition 3-1. In some embodiments, the number of transmission occasions is 1, and default beam-1 is applied to the transmission occasion. In some embodiments, the number of transmission occasions is 2. And default beam-1 is applied to both of the two transmission occasions.

In some embodiments, in case of Condition 1-1 and Condition 2-2 and Condition 3-2 or in case of Condition 1-1 and Condition 2-2 and Condition 3-1 or in case of Condition 1-2 and Condition 2-2 and Condition 3-1. In some embodiments, the number of transmission occasions is 2. And the first TCI state of default beam-2 is applied to the first transmission occasion, and the second TCI of default beam-2 is applied to the second transmission occasion. In some embodiments, the number of transmission occasions is 1. And the first or second TCI state of default beam-2 is applied to the transmission occasion. In some embodiments, the number of transmission occasions is 2. And the first or second TCI state of default beam-2 is applied to both the two transmission occasions.

In some embodiments, in case of Condition 1-2 and Condition 2-1 and Condition 3-2. In some embodiments, the number of transmission occasions is 2. And the one indicated TCI state by the DCI field ‘Transmission Configuration Indication’ is applied to the two transmission occasions. In some embodiments, the number of transmission occasions is 1. And the one indicated TCI state by the DCI field ‘Transmission Configuration Indication’ is applied to the transmission occasion.

In some embodiments, in case of Condition 1-2 and Condition 2-2 and Condition 3-1. In some embodiments, the number of transmission occasions is derived by the number of TCI states indicated by the DCI field ‘Transmission Configuration Indication’ of the scheduling DCI. And one or two TCI states of default beam-2 is applied to the transmission occasion(s). For example, if the number of indicated TCI states is 1, the number of transmission occasions is 1, and the first or second TCI state of default beam-2 is applied to the transmission occasion. For another example, if the number of indicated TCI states is 2, the number of transmission occasions is 2, and the first TCI state of default beam-2 is applied to the first transmission occasion, and the second TCI state of default beam-2 is applied to the second transmission occasion.

In some embodiments, if tci-PresentInDCI and/or tci-PresentInDCI-ForFormat1_2 is not configured, and/or if no TCI codepoints are mapped to two different TCI states and if the offset between the reception of the DL DCI and the corresponding PDSCH (or at least one transmission occasions) is less than the threshold timeDurationForQCL, the UE may assume that the DM-RS ports of PDSCH of a serving cell are quasi co-located with the RS(s) with respect to the QCL parameter(s) used for PDCCH quasi co-location indication of the CORESET associated with a monitored search space with the lowest controlResourceSetld in the latest slot in which one or more CORESETs within the active BWP of the serving cell are monitored by the UE.

In some embodiments, when a UE is configured by higher layer parameter RepSchemeEnabler set to one of ‘FDMSchemeA’ or ‘FDMSchemeB’, the UE shall receive a single transmission occasion of the TB, and the UE may assume that the DM-RS ports of the single transmission occasion are quasi co-located with the RS(s) with respect to the QCL parameter(s) used for PDCCH quasi co-location indication of the CORESET associated with a monitored search space with the lowest controlResourceSetId in the latest slot in which one or more CORESETs within the active BWP of the serving cell are monitored by the UE. For example, if P′_{BWP,i} is determined as “wideband”, the first

$$⌈ \frac{{n}_{P R B}}{2} ⌉$$

PRBs or the remaining

$$⌊ \frac{{n}_{P R B}}{2} ⌋$$

PRBs are assigned to the transmission occasion, where n_{PRB} is the total number of allocated PRBs for the UE. For another example, if P′_{BWP,i} is determined as one of the values among {2, 4}, even or odd PRGs within the allocated frequency domain resources are assigned to the transmission occasion.

In some embodiments, when a UE is configured by higher layer parameter RepSchemeEnabler set to ‘FDMSchemeA’ or ‘FDMSchemeB’, the UE shall receive a single transmission occasion of the TB, and the UE may assume that the DM-RS ports of the single transmission occasion are quasi co-located with the RS(s) with respect to the QCL parameter(s) used for PDCCH quasi co-location indication of the CORESET associated with a monitored search space with the lowest controlResourceSetId in the latest slot in which one or more CORESETs within the active BWP of the serving cell are monitored by the UE. And the n_{PRB} PRBs are assigned to the transmission occasion, where n_{PRB} is the total number of allocated PRBs for the UE.

In some embodiments, when a UE is configured by higher layer parameter RepSchemeEnabler set to ‘FDMSchemeA’ or ‘FDMSchemeB’, the UE shall receive two PDSCH transmission occasions of the same TB, and the UE may assume that the DM-RS ports of the two transmission occasions are quasi co-located with the RS(s) with respect to the QCL parameter(s) used for PDCCH quasi co-location indication of the CORESET associated with a monitored search space with the lowest controlResourceSetld in the latest slot in which one or more CORESETs within the active BWP of the serving cell are monitored by the UE. For example, if P′_{BWP,i} is determined as “wideband”, me first

$$⌈ \frac{{n}_{P R B}}{2} ⌉$$

PRBs are assigned to the first transmission occasion and the remaining

$$⌊ \frac{{n}_{P R B}}{2} ⌋$$

PRBs are assigned to the second transmission occasion, where n_{PRB} is the total number of allocated PRBs for the UE. For another example, if P′_{BWP,i is determined as one of the values among {}2, 4}, even PRGs within the allocated frequency domain resources are assigned to the first transmission occasion, and odd PRGs within the allocated frequency domain resources are assigned to the second transmission occasion.

In some embodiments, when a UE is configured by higher layer parameter RepSchemeEnabler set to ‘TDMSchemeA’, the UE shall receive a single transmission occasion of the TB, and the UE may assume that the DM-RS ports of the single transmission occasion are quasi co-located with the RS(s) with respect to the QCL parameter(s) used for PDCCH quasi co-location indication of the CORESET associated with a monitored search space with the lowest controlResourceSetld in the latest slot in which one or more CORESETs within the active BWP of the serving cell are monitored by the UE.

In some embodiments, when a UE is configured by higher layer parameter RepSchemeEnabler set to ‘TDMSchemeA’, the UE shall receive two transmission occasions. In some embodiments, the resource allocation in time domain for the first transmission occasion follows Clause “Resource allocation in time domain” (for example, clause 5.1.2.1) in TS 38.214. And the second PDSCH transmission occasion shall have the same number of symbols as the first PDSCH transmission occasion. And the UE may assume that the DM-RS ports of the two transmission occasions are quasi co-located with the RS(s) with respect to the QCL parameter(s) used for PDCCH quasi co-location indication of the CORESET associated with a monitored search space with the lowest controlResourceSetld in the latest slot in which one or more CORESETs within the active BWP of the serving cell are monitored by the UE. In some embodiments, if the UE is configured by the higher layers with a value K̅ in StartingSymbolOffsetK, it shall determine that the first symbol of the second transmission occasion starts after K̅ symbols from the last symbol of the first transmission occasion. If the value K̅ is not configured via the higher layer parameter StartingSymbolOffsetK, K̅=0 shall be assumed by the UE. The UE is not expected to receive more than two PDSCH transmission layers for each PDSCH transmission occasion. For two transmission occasions, the redundancy version to be applied is derived according to Table 5.1.2.1-2 in TS 38.214, where n=0, 1 applied respectively to the first and second transmission occasions.

In some embodiments, when a UE is configured by the higher layer parameter PDSCH-config that indicates at least one entry in pdsch-TimeDomainAllocationList contain RepNumR16 in PDSCH-TimeDomainResourceAllocation. If the DCI field “Time domain resource assignment’ indicating an entry in pdsch-TimeDomainAllocationList which contain RepNumR16 in PDSCH-TimeDomainResourceAllocation and/or DM-RS port(s) within one CDM group in the DCI field “Antenna Port(s)”, the same SLIV is applied for all transmission occasions. There are RepNumR16 transmission occasions, and the UE may assume that the DM-RS ports of the transmission occasions are quasi co-located with the RS(s) with respect to the QCL parameter(s) used for PDCCH quasi co-location indication of the CORESET associated with a monitored search space with the lowest controlResourceSetld in the latest slot in which one or more CORESETs within the active BWP of the serving cell are monitored by the UE. And the resource allocation in time domain for the first transmission occasion follows Clause “Resource allocation in time domain” (for example, clause 5.1.2.1) in TS 38.214. For all transmission occasions, the redundancy version to be applied is derived according to Table 5.1.2.1-2 [TS 38.214], where n=0, 1, . . . RepNumR16 -1. Or alternatively, for all transmission occasions, the redundancy version to be applied is derived according to Table 5.1.2.1-2 [TS 38.214], where n is counted considering PDSCH transmission occasions.

In some embodiments, when a UE is configured by the higher layer parameter PDSCH-config that indicates at least one entry in pdsch-TimeDomainAllocationList contain RepNumR16 in PDSCH-TimeDomainResourceAllocation. If the DCI field “Time domain resource assignment’ indicating an entry in pdsch-TimeDomainAllocationList which contain RepNumR16 in PDSCH-TimeDomainResourceAllocation and/or DM-RS port(s) within one CDM group in the DCI field “Antenna Port(s)”. There is only one transmission occasion, and the UE may assume that the DM-RS ports of the transmission occasion are quasi co-located with the RS(s) with respect to the QCL parameter(s) used for PDCCH quasi co-location indication of the CORESET associated with a monitored search space with the lowest controlResourceSetld in the latest slot in which one or more CORESETs within the active BWP of the serving cell are monitored by the UE. And the resource allocation in time domain for the single transmission occasion follows Clause “Resource allocation in time domain” (for example, clause 5.1.2.1) in TS 38.214.

In some embodiments, if tci-PresentInDCI and/or tci-PresentInDCI-ForFormat1_2 is not configured, and/or if at least one configured TCI states for the serving cell of scheduled PDSCH contains the ‘QCL-TypeD’, and/or if at least one TCI codepoint indicates two TCI states, and if the offset between the reception of the DL DCI and the corresponding PDSCH (or transmission occasions) is less than the threshold timeDurationForQCL, the UE may assume that the DM-RS ports of PDSCH of a serving cell are quasi co-located with the RS(s) with respect to the QCL parameter(s) associated with the first TCI state of the two TCI states corresponding to the lowest codepoint among the TCI codepoints containing two different TCI states.

In some embodiments, when a UE is configured by higher layer parameter RepSchemeEnabler set to one of ‘FDMSchemeA’ or ‘FDMSchemeB’, the UE shall receive a single transmission occasion of the TB with the first TCI state corresponding to the lowest codepoint among the TCI codepoints containing two different TCI states associated to the transmission occasion with frequency domain resource allocation as described in clause “Physical resource block (PRB) bundling” (for example Clause 5.1.2.3) in TS 38.214. For example, if P′_{BWP,i} is determined as “wideband”, the first

$$⌈ \frac{{n}_{P R B}}{2} ⌉$$

PRBs or the remaining

$$⌊ \frac{{n}_{P R B}}{2} ⌋$$

PRBs are assigned to the transmission occasion, where n_{PRB} is the total number of allocated PRBs for the UE. For another example, if P′_{BWP,i} is determined as one of the values among {2, 4}, even or odd PRGs within the allocated frequency domain resources are assigned to the transmission occasion.

In some embodiments, when a UE is configured by higher layer parameter RepSchemeEnabler set to ‘FDMSchemeA’ or ‘FDMSchemeB’, the UE shall receive a single transmission occasion of the TB with the first TCI state corresponding to the lowest codepoint among the TCI codepoints containing two different TCI states associated to the transmission occasion with frequency domain resource allocation as described in clause “Physical resource block (PRB) bundling” (for example Clause 5.1.2.3) in TS 38.214. And the n_{PRB} PRBs are assigned to the transmission occasion, where n_{PRB} is the total number of allocated PRBs for the UE.

In some embodiments, when a UE is configured by higher layer parameter RepSchemeEnabler set to ‘FDMSchemeA’ or ‘FDMSchemeB’, the UE shall receive two PDSCH transmission occasions of the same TB with the first TCI state corresponding to the lowest codepoint among the TCI codepoints containing two different TCI states associated to each non-overlapping frequency domain resource allocation as described in clause “Physical resource block (PRB) bundling” (for example Clause 5.1.2.3) in TS 38.214. For example, if P′_{BWP,i} is determined as “wideband”, the first

$$⌈ \frac{{n}_{P R B}}{2} ⌉$$

PRBs are assigned to the first transmission occasion and the remaining

$$⌊ \frac{{n}_{P R B}}{2} ⌋$$

PRBs are assigned to the second transmission occasion, where n_{PRB} is the total number of allocated PRBs for the UE. For another example, if P′_{BWP,i} is determined as one of the values among {2, 4}, even PRGs within the allocated frequency domain resources are assigned to the first transmission occasion, and odd PRGs within the allocated frequency domain resources are assigned to the second transmission occasion.

In some embodiments, when a UE is configured by higher layer parameter RepSchemeEnabler set to ‘TDMSchemeA’, the UE shall receive a single transmission occasion of the TB with the first TCI state corresponding to the lowest codepoint among the TCI codepoints containing two different TCI states associated to the transmission occasion with time domain resource allocation as described in Clause “Resource allocation in time domain” (for example, clause 5.1.2.1) in TS 38.214.

In some embodiments, when a UE is configured by higher layer parameter RepSchemeEnabler set to ‘TDMSchemeA’, the UE shall receive two transmission occasions, where the first TCI state corresponding to the lowest codepoint among the TCI codepoints containing two different TCI states is applied to the two transmission occasions. In some embodiments, the resource allocation in time domain for the first transmission occasion follows Clause “Resource allocation in time domain” (for example, clause 5.1.2.1) in TS 38.214. And the second PDSCH transmission occasion shall have the same number of symbols as the first PDSCH transmission occasion. In some embodiments, if the UE is configured by the higher layers with a value K̅ in StartingSymbolOffsetK, it shall determine that the first symbol of the second transmission occasion starts after K̅ symbols from the last symbol of the first transmission occasion. If the value K̅ is not configured via the higher layer parameter StartingSymbolOffsetK, K̅=0 shall be assumed by the UE. The UE is not expected to receive more than two PDSCH transmission layers for each PDSCH transmission occasion. For two transmission occasions, the redundancy version to be applied is derived according to Table 5.1.2.1-2 in TS 38.214, where n=0, 1 applied respectively to the first and second transmission occasions.

In some embodiments, when a UE is configured by the higher layer parameter PDSCH-config that indicates at least one entry in pdsch-TimeDomainAllocationList contain RepNumR16 in PDSCH-TimeDomainResourceAllocation. If the DCI field “Time domain resource assignment’ indicating an entry in pdsch-TimeDomainAllocationList which contain RepNumR16 in PDSCH-TimeDomainResourceAllocation and/or DM-RS port(s) within one CDM group in the DCI field “Antenna Port(s)”, the same SLIV is applied for all transmission occasions. There are RepNumR16 transmission occasions, and the first TCI state corresponding to the lowest codepoint among the TCI codepoints containing two different TCI states is applied to the RepNumR16 PDSCH transmission occasions. And the resource allocation in time domain for the first transmission occasion follows Clause “Resource allocation in time domain” (for example, clause 5.1.2.1) in TS 38.214. For all transmission occasions, the redundancy version to be applied is derived according to Table 5.1.2.1-2 [TS 38.214], where n=0, 1, . . . RepNumR16-1. Or alternatively, for all transmission occasions, the redundancy version to be applied is derived according to Table 5.1.2.1-2 [TS 38.214], where n is counted considering PDSCH transmission occasions.

In some embodiments, when a UE is configured by the higher layer parameter PDSCH-config that indicates at least one entry in pdsch-TimeDomainAllocationList contain RepNumR16 in PDSCH-TimeDomainResourceAllocation. If the DCI field “Time domain resource assignment’ indicating an entry in pdsch-TimeDomainAllocationList which contain RepNumR16 in PDSCH-TimeDomainResourceAllocation and/or DM-RS port(s) within one CDM group in the DCI field “Antenna Port(s)”. There is only one transmission occasion, and the first TCI state corresponding to the lowest codepoint among the TCI codepoints containing two different TCI states is applied to the PDSCH transmission occasion. And the resource allocation in time domain for the single transmission occasion follows Clause “Resource allocation in time domain” (for example, clause 5.1.2.1) in TS 38.214.

In some embodiments, if tci-PresentInDCI and/or tci-PresentInDCI-ForFormat1_2 is not configured, and/or if at least one configured TCI states for the serving cell of scheduled PDSCH contains the ‘QCL-TypeD’, and/or if at least one TCI codepoint indicates two TCI states, and if the offset between the reception of the DL DCI and the corresponding PDSCH (or transmission occasions) is less than the threshold timeDurationForQCL, the UE may assume that the DM-RS ports of PDSCH of a serving cell are quasi co-located with the RS(s) with respect to the QCL parameter(s) associated with the TCI states corresponding to the lowest codepoint among the TCI codepoints containing two different TCI states.

In some embodiments, when a UE is configured by higher layer parameter RepSchemeEnabler set to one of ‘FDMSchemeA’ or ‘FDMSchemeB’, the UE shall receive a single transmission occasion of the TB with the each TCI state of the two TCI states corresponding to the lowest codepoint among the TCI codepoints containing two different TCI states associated to the transmission occasion with frequency domain resource allocation as described in clause “Physical resource block (PRB) bundling” (for example Clause 5.1.2.3) in TS 38.214. For example, if P′_{BWP,i} is determined as “wideband”, the first

$$⌈ \frac{{n}_{P R B}}{2} ⌉$$

PRBs are assigned to the tirst TCI state of the two TCI states corresponding to the lowest codepoint among the TCI codepoints containing two different TCI states and the remaining

$$⌊ \frac{{n}_{P R B}}{2} ⌋$$

PRBs are assigned to me second TCI state of the two TCI states corresponding to the lowest codepoint among the TCI codepoints containing two different TCI states, where n_{PRB} is the total number of allocated PRBs for the UE. For example, if P′_{BWP,i} is determined as one of the values among {2, 4}, even PRGs within the allocated frequency domain resources are assigned to the first TCI state of the two TCI states corresponding to the lowest codepoint among the TCI codepoints containing two different TCI states and odd PRGs within the allocated frequency domain resources are assigned to the second TCI state of the two TCI states corresponding to the lowest codepoint among the TCI codepoints containing two different TCI states. In some embodiments, the UE is not expected to receive more than two PDSCH transmission layers for each PDSCH transmission occasion.

In some embodiments, when a UE is configured by higher layer parameter RepSchemeEnabler set to ‘FDMSchemeA’ or ‘FDMSchemeB’, the UE shall receive two PDSCH transmission occasions of the same TB with each TCI state of the two TCI states corresponding to the lowest codepoint among the TCI codepoints containing two different TCI states associated to a transmission occasion which has non-overlapping frequency domain resource allocation as described in clause “Physical resource block (PRB) bundling” (for example Clause 5.1.2.3) in TS 38.214. For example, if P′_{BWP,i} is determined as “wideband”, the first

$$⌈ \frac{{n}_{P R B}}{2} ⌉$$

PRB s are assigned to me nrst TCI state of the two TCI states corresponding to the lowest codepoint among the TCI codepoints containing two different TCI states and the remaining

$$⌊ \frac{{n}_{P R B}}{2} ⌋$$

PRBs are assigned to the second TCI state of the two TCI states corresponding to the lowest codepoint among the TCI codepoints containing two different TCI states, where n_{PRB} is the total number of allocated PRBs for the UE. For another example, if P′_{BWP,i} is determined as one of the values among {2, 4}, even PRGs within the allocated frequency domain resources are assigned to the first TCI state of the two TCI states corresponding to the lowest codepoint among the TCI codepoints containing two different TCI states, and odd PRGs within the allocated frequency domain resources are assigned to the second TCI state of the two TCI states corresponding to the lowest codepoint among the TCI codepoints containing two different TCI states.

In some embodiments, when a UE is configured by higher layer parameter

RepSchemeEnabler set to ‘TDMSchemeA’, the UE shall receive a single transmission occasion of the TB with the first TCI state corresponding to the lowest codepoint among the TCI codepoints containing two different TCI states associated to the transmission occasion with time domain resource allocation as described in Clause “Resource allocation in time domain” (for example, clause 5.1.2.1) in TS 38.214.

In some embodiments, when a UE is configured by higher layer parameter RepSchemeEnabler set to ‘TDMSchemeA’, the UE shall or is expected to receive two transmission occasions, where the first TCI state of the two TCI states corresponding to the lowest codepoint among the TCI codepoints containing two different TCI states is applied to the first PDSCH transmission occasion and resource allocation in time domain for the first PDSCH transmission occasion follows Clause “Resource allocation in time domain” (for example, clause 5.1.2.1) in TS 38.214. The second TCI state of the two TCI states corresponding to the lowest codepoint among the TCI codepoints containing two different TCI states is applied to the second PDSCH transmission occasion, and the second PDSCH transmission occasion shall have the same number of symbols as the first PDSCH transmission occasion. In some embodiments, if the UE is configured by the higher layers with a value K̅ in StartingSymbolOffsetK, it shall determine that the first symbol of the second transmission occasion starts after K̅ symbols from the last symbol of the first transmission occasion. If the value K̅0 is not configured via the higher layer parameter StartingSymbolOffsetK, K̅=0 shall be assumed by the UE. The UE is not expected to receive more than two PDSCH transmission layers for each PDSCH transmission occasion. For two transmission occasions, the redundancy version to be applied is derived according to Table 5.1.2.1-2 in TS 38.214, where n=0, 1 applied respectively to the first and second transmission occasions.

In some embodiments, when a UE is configured by the higher layer parameter PDSCH-config that indicates at least one entry in pdsch-TimeDomainAllocationList contain RepNumR16 in PDSCH-TimeDomainResourceAllocation. If the DCI field “Time domain resource assignment’ indicating an entry in pdsch-TimeDomainAllocationList which contain RepNumR16 in PDSCH-TimeDomainResourceAllocation and/or DM-RS port(s) within one CDM group in the DCI field “Antenna Port(s)”, the same SLIV is applied for all transmission occasions. There are RepNumR16 transmission occasions, and the first TCI state of the two TCI states corresponding to the lowest codepoint among the TCI codepoints containing two different TCI states is applied to the first transmission occasion and resource allocation in time domain for the first transmission occasion follows Clause “Resource allocation in time domain” (for example, clause 5.1.2.1) in TS 38.214. When the value indicated by RepNumR16 in PDSCH-TimeDomainResourceAllocation equals to two, the second TCI state of the two TCI states corresponding to the lowest codepoint among the TCI codepoints containing two different TCI states is applied to the second transmission occasion. In some embodiments, when the value indicated by RepNumR16 in PDSCH-TimeDomainResourceAllocation is larger than two, the UE may be further configured to enable CycMapping or SeqMapping in RepTCIMapping. For example, when CycMapping is enabled, the first and second TCI states of the two TCI states corresponding to the lowest codepoint among the TCI codepoints containing two different TCI states are applied to the first and second transmission occasions, respectively, and the same TCI mapping pattern continues to the remaining transmission occasions. For example, when SeqMapping is enabled, first TCI state of the two TCI states corresponding to the lowest codepoint among the TCI codepoints containing two different TCI states is applied to the first and second transmission occasions, and the second TCI state of the two TCI states corresponding to the lowest codepoint among the TCI codepoints containing two different TCI states is applied to the third and/or fourth transmission occasions (For example, the fourth transmission occasion exists), and the same TCI mapping pattern continues to the remaining transmission occasions. In some embodiments, the UE may expect that each transmission occasion is limited to two transmission layers. In some embodiments, for all transmission occasions associated with the first TCI state of the two TCI states corresponding to the lowest codepoint among the TCI codepoints containing two different TCI states, the redundancy version to be applied is derived according to Table 5.1.2.1-2 [TS 38.214], where n is counted only considering transmission occasions associated with the first TCI state of the two TCI states corresponding to the lowest codepoint among the TCI codepoints containing two different TCI states. The redundancy version for transmission occasions associated with the second TCI state of the two TCI states corresponding to the lowest codepoint among the TCI codepoints containing two different TCI states is derived according to Table 5.1.2.1-3 [TS 38.214], where additional shifting operation for each redundancy version rvₛ is configured by higher layer parameter RVSeqOffset and n is counted only considering transmission occasions associated with the second TCI state of the two TCI states corresponding to the lowest codepoint among the

TCI codepoints containing two different TCI states.

In some embodiments, when a UE is with scheme 2a or scheme 2b or scheme 3 or scheme 4 or a UE is configured by the higher layer parameter RepSchemeEnabler set to “TDMSchemeA” or “FDMSchemeA” or “FDMSchemeB” or a UE configured by the higher layer parameter PDSCH-config that indicates at least one entry in pdsch-TimeDomainAllocationList contain RepNumR16 in PDSCH-TimeDomainResourceAllocation and/or indicated DM-RS port(s) within one CDM group in the DCI field “Antenna Port(s)”, if no TCI codepoints are mapped to two different TCI states, the UE is expected to receive a single PDSCH transmission occasion, and the resource allocation in the time domain follows Clause “Resource allocation in time domain” (for example, clause 5.1.2.1) in TS 38.214.

In some embodiments, if one or two of the TCI states corresponding to the lowest codepoint among the TCI codepoints containing two different TCI states are applied to transmission occasion(s), the TCI state(s) indicated by the DCI field ‘Transmission Configuration Indication’ (if the field is present) of the scheduling DCI is ignored.

In some embodiments, when a UE is configured by higher layer parameter RepSchemeEnabler set to one of ‘FDMSchemeA’, ‘FDMSchemeB’, ‘TDMSchemeA’, if the UE is indicated with two TCI states in a codepoint of the DCI field ‘Transmission Configuration Indication’ and DM-RS port(s) within one CDM group in the DCI field “Antenna Port(s)”. And if the offset between the reception of the DL DCI and the corresponding PDSCH is larger than or equal to the threshold timeDurationForQCL and at least one configured TCI states for the serving cell of scheduled PDSCH contains the ‘QCL-TypeD’, or if none of configured TCI states for the serving cell of scheduled PDSCH contains ‘QCL-TypeD’. For example, when two TCI states are indicated in a DCI and the UE is set to ‘FDMSchemeA’, the UE shall receive a single PDSCH transmission occasion of the TB with each TCI state associated to a non-overlapping frequency domain resource allocation as described in clause “Physical resource block (PRB) bundling” (for example Clause 5.1.2.3) in TS 38.214. For example, when two TCI states are indicated in a DCI and the UE is set to ‘FDMSchemeB’, the UE shall receive two PDSCH transmission occasions of the same TB with each TCI state associated to a PDSCH transmission occasion which has non-overlapping frequency domain resource allocation with respect to the other PDSCH transmission occasion as described in clause “Physical resource block (PRB) bundling” (for example Clause 5.1.2.3) in TS 38.214. For example, when two TCI states are indicated in a DCI and the UE is set to ‘TDMSchemeA’, the UE shall receive two PDSCH transmission occasions of the same TB with each TCI state associated to a PDSCH transmission occasion which has non-overlapping time domain resource allocation with respect to the other PDSCH transmission occasion and both PDSCH transmission occasions shall be received within a given slot as described in Clause “Resource allocation in time domain” (for example, clause 5.1.2.1) in TS 38.214. And if the offset between the reception of the DL DCI and the corresponding PDSCH is less than the threshold timeDurationForQCL and at least one configured TCI states for the serving cell of scheduled PDSCH contains the ‘QCL-TypeD’, the UE may assume that the DM-RS ports of PDSCH of a serving cell are quasi co-located with the RS(s) with respect to the QCL parameter(s) associated with the TCI states corresponding to the lowest codepoint among the TCI codepoints containing two different TCI states. For example, when the UE is set to ‘FDMSchemeA’, the UE shall receive a single PDSCH transmission occasion of the TB with each TCI state associated to a non-overlapping frequency domain resource allocation as described in clause “Physical resource block (PRB) bundling” (for example Clause 5.1.2.3) in TS 38.214. For example, when the UE is set to ‘FDMSchemeB’, the UE shall receive two PDSCH transmission occasions of the same TB with each TCI state associated to a PDSCH transmission occasion which has non-overlapping frequency domain resource allocation with respect to the other PDSCH transmission occasion as described in clause “Physical resource block (PRB) bundling” (for example Clause 5.1.2.3) in TS 38.214. For example, when the UE is set to ‘TDMSchemeA’, the UE shall receive two PDSCH transmission occasions of the same TB with each TCI state associated to a PDSCH transmission occasion which has non-overlapping time domain resource allocation with respect to the other PDSCH transmission occasion and both PDSCH transmission occasions shall be received within a given slot as described in Clause “Resource allocation in time domain” (for example, clause 5.1.2.1) in TS 38.214. Otherwise, the UE may expect to receive a single PDSCH where the association between the DM-RS ports and the TCI states are as defined in Clause “DMRS reception procedure” (for example, clause 5.1.6.2) in TS 38.214.

In some embodiments, when a UE is configured by the higher layer parameter PDSCH-config that indicates at least one entry in pdsch-TimeDomainAllocationList containing RepNumR16 in PDSCH-TimeDomainResourceAllocation. And if the offset between the reception of the DL DCI and the corresponding PDSCH is larger than or equal to the threshold timeDurationForQCL and at least one configured TCI states for the serving cell of scheduled PDSCH contains the ‘QCL-TypeD’, or if none of configured TCI states for the serving cell of scheduled PDSCH contains ‘QCL-TypeD’, the UE may expect to be indicated with one or two TCI states in a codepoint of the DCI field ‘Transmission Configuration Indication’ together with the DCI field “Time domain resource assignment’ indicating an entry in pdsch-TimeDomainAllocationList which contain RepNum16 in PDSCH-TimeDomainResourceAllocation and DM-RS port(s) within one CDM group in the DCI field “Antenna Port(s)”. For example, when two TCI states are indicated in a DCI with ‘Transmission Configuration Indication’ field, the UE may expect to receive multiple slot level PDSCH transmission occasions of the same TB with two TCI states used across multiple PDSCH transmission occasions as defined in Clause “Resource allocation in time domain” (for example, clause 5.1.2.1) in TS 38.214. For example, when one TCI state is indicated in a DCI with ‘Transmission Configuration Indication’ field, the UE may expect to receive multiple slot level PDSCH transmission occasions of the same TB with one TCI state used across multiple PDSCH transmission occasions as defined in Clause “Resource allocation in time domain” (for example, clause 5.1.2.1) in TS 38.214. And if the offset between the reception of the DL DCI and the corresponding PDSCH is less than the threshold timeDurationForQCL and at least one configured TCI states for the serving cell of scheduled PDSCH contains the ‘QCL-TypeD’, the UE may assume that the DM-RS ports of PDSCH of a serving cell are quasi co-located with the RS(s) with respect to the QCL parameter(s) associated with the TCI states corresponding to the lowest codepoint among the TCI codepoints containing two different TCI states, and if the UE is indicated with the DCI field “Time domain resource assignment’ indicating an entry in pdsch-TimeDomainAllocationList which contain RepNum16 in PDSCH-TimeDomainResourceAllocation and DM-RS port(s) within one CDM group in the DCI field “Antenna Port(s)”, the UE may expect to receive multiple slot level PDSCH transmission occasions of the same TB with two TCI states used across multiple PDSCH transmission occasions as defined in Clause “Resource allocation in time domain” (for example, clause 5.1.2.1) in TS 38.214. Otherwise, the UE may expect to receive a single PDSCH where the association between the DM-RS ports and the TCI states are as defined in Clause “DMRS reception procedure” (for example, clause 5.1.6.2) in TS 38.214.

In some embodiments, when a UE is configured by higher layer parameter RepSchemeEnabler set to one of ‘FDMSchemeA’, ‘FDMSchemeB’, ‘TDMSchemeA’, if the UE is indicated with two TCI states in a codepoint of the DCI field ‘Transmission Configuration Indication’ and DM-RS port(s) within one CDM group in the DCI field “Antenna Port(s)”or if the UE assumes two TCI states corresponding to the lowest codepoint among the TCI codepoints containing two different TCI states as described in Clause “Antenna ports quasi co-location” (for example, Clause 5.1.5) in TS 38.214. When two TCI states are indicated in a DCI or when two TCI states are assumed, and the UE is set to ‘FDMSchemeA’, the UE shall receive a single PDSCH transmission occasion of the TB with each TCI state associated to a non-overlapping frequency domain resource allocation as described in clause “Physical resource block (PRB) bundling” (for example Clause 5.1.2.3) in TS 38.214. When two TCI states are indicated in a DCI or when two TCI states are assumed, and the UE is set to ‘FDMSchemeB’, the UE shall receive two PDSCH transmission occasions of the same TB with each TCI state associated to a PDSCH transmission occasion which has non-overlapping frequency domain resource allocation with respect to the other PDSCH transmission occasion as described in clause “Physical resource block (PRB) bundling” (for example Clause 5.1.2.3) in TS 38.214. When two TCI states are indicated in a DCI or when two TCI states are assumed, and the UE is set to ‘TDMSchemeA’, the UE shall receive two PDSCH transmission occasions of the same TB with each TCI state associated to a PDSCH transmission occasion which has non-overlapping time domain resource allocation with respect to the other PDSCH transmission occasion and both PDSCH transmission occasions shall be received within a given slot as described in Clause “Resource allocation in time domain” (for example, clause 5.1.2.1) in TS 38.214. Otherwise, the UE may expect to receive a single PDSCH where the association between the DM-RS ports and the TCI states are as defined in Clause “DMRS reception procedure” (for example, clause 5.1.6.2) in TS 38.214.

In some embodiments, when a UE is configured by the higher layer parameter PDSCH-config that indicates at least one entry in pdsch-TimeDomainAllocationList containing RepNumR16 in PDSCH-TimeDomainResourceAllocation, the UE may expect to be indicated with one or two TCI states in a codepoint of the DCI field ‘Transmission Configuration Indication’ together with the DCI field “Time domain resource assignment’ indicating an entry in pdsch-TimeDomainAllocationList which contain RepNum16 in PDSCH-TimeDomainResourceAllocation and DM-RS port(s) within one CDM group in the DCI field “Antenna Port(s)”. When two TCI states are indicated in a DCI with ‘Transmission Configuration Indication’ field or when two TCI states are assumed, the UE may expect to receive multiple slot level PDSCH transmission occasions of the same TB with two TCI states used across multiple PDSCH transmission occasions as defined in Clause “Resource allocation in time domain” (for example, clause 5.1.2.1) in TS 38.214. When one TCI state is indicated in a DCI with ‘Transmission Configuration Indication’ field, the UE may expect to receive multiple slot level PDSCH transmission occasions of the same TB with one TCI state used across multiple PDSCH transmission occasions as defined in Clause “Resource allocation in time domain” (for example, clause 5.1.2.1) in TS 38.214. Otherwise, the UE may expect to receive a single PDSCH where the association between the DM-RS ports and the TCI states are as defined in Clause “DMRS reception procedure” (for example, clause 5.1.6.2) in TS 38.214.

In some embodiments, when a UE is configured by the higher layer parameter RepSchemeEnabler set to ‘TDMSchemeA’ and indicated DM-RS port(s) within one CDM group in the DCI field “Antenna Port(s)”. And the number of PDSCH transmission occasions is derived by the number of TCI states indicated by the DCI field ‘Transmission Configuration Indication’ of the scheduling DCI if the offset between the reception of the DL DCI and the corresponding PDSCH is larger than or equal to the threshold timeDurationForQCL and at least one configured TCI states for the serving cell of scheduled PDSCH contains the ‘QCL-TypeD’, or if none of configured TCI states for the serving cell of scheduled PDSCH contains ‘QCL-TypeD’. If two TCI states are indicated by the DCI field ‘Transmission Configuration Indication’, the UE is expected to receive two PDSCH transmission occasions, where the first TCI state is applied to the first PDSCH transmission occasion and resource allocation in time domain for the first PDSCH transmission occasion follows Clause “Resource allocation in time domain” (for example, clause 5.1.2.1) in TS 38.214. The second TCI state is applied to the second PDSCH transmission occasion, and the second PDSCH transmission occasion shall have the same number of symbols as the first PDSCH transmission occasion. If the UE is configured by the higher layers with a value K̅ in StartingSymbolOffsetK, it shall determine that the first symbol of the second PDSCH transmission occasion starts after K̅ symbols from the last symbol of the first PDSCH transmission occasion. If the value K̅ is not configured via the higher layer parameter StartingSymbolOffsetK, K̅=0 shall be assumed by the UE. The UE is not expected to receive more than two PDSCH transmission layers for each PDSCH transmission occasion. For two PDSCH transmission occasions, the redundancy version to be applied is derived according to Table 5.1.2.1-2 in TS 38.214, where n =0, 1 applied respectively to the first and second TCI state. Otherwise, the UE is expected to receive a single PDSCH transmission occasion, and the resource allocation in the time domain follows Clause “Resource allocation in time domain” (for example, clause 5.1.2.1) in TS 38.214. And the number of PDSCH transmission occasions is two if the offset between the reception of the DL DCI and the corresponding PDSCH is less than the threshold timeDurationForQCL and at least one configured TCI states for the serving cell of scheduled PDSCH contains the ‘QCL-TypeD’. the UE is expected to receive two PDSCH transmission occasions, where the first TCI state corresponding to the lowest codepoint among the TCI codepoints containing two different TCI states is applied to the first PDSCH transmission occasion and resource allocation in time domain for the first PDSCH transmission occasion follows Clause 5.1.2.1. The second TCI state corresponding to the lowest codepoint among the TCI codepoints containing two different TCI states is applied to the second PDSCH transmission occasion, and the second PDSCH transmission occasion shall have the same number of symbols as the first PDSCH transmission occasion. If the UE is configured by the higher layers with a value K̅ in StartingSymbolOffsetK, it shall determine that the first symbol of the second PDSCH transmission occasion starts after K̅ symbols from the last symbol of the first PDSCH transmission occasion. If the value K̅ is not configured via the higher layer parameter StartingSymbolOffsetK, K̅=0 shall be assumed by the UE. The UE is not expected to receive more than two PDSCH transmission layers for each PDSCH transmission occasion. For two PDSCH transmission occasions, the redundancy version to be applied is derived according to Table 5.1.2.1-2 in TS 38.214, where n=0, 1 applied respectively to the first and second TCI state. Otherwise, the UE is expected to receive a single PDSCH transmission occasion, and the resource allocation in the time domain follows Clause “Resource allocation in time domain” (for example, clause 5.1.2.1) in TS 38.214.

In some embodiments, when a UE configured by the higher layer parameter PDSCH-config that indicates at least one entry in pdsch-TimeDomainAllocationList contain RepNumR16 in PDSCH-TimeDomainResourceAllocation.

And if two TCI states are indicated by the DCI field ‘Transmission Configuration Indication’ or if the UE assumes two TCI states corresponding to the lowest codepoint among the TCI codepoints containing two different TCI states as described in Clause “Antenna ports quasi co-location” (for example, Clause 5.1.5) in TS 38.214, and with the DCI field “Time domain resource assignment’ indicating an entry in pdsch-TimeDomainAllocationList which contain RepNumR16 in PDSCH-TimeDomainResourceAllocation and DM-RS port(s) within one CDM group in the DCI field “Antenna Port(s)”, the same SLIV is applied for all PDSCH transmission occasions, the first TCI state is applied to the first PDSCH transmission occasion and resource allocation in time domain for the first PDSCH transmission occasion follows Clause “Resource allocation in time domain” (for example, clause 5.1.2.1) in TS 38.214. When the value indicated by RepNumR16 in PDSCH-TimeDomainResourceAllocation equals to two, the second TCI state is applied to the second PDSCH transmission occasion. When the value indicated by RepNumR16 in PDSCH-TimeDomainResourceAllocation is larger than two, the UE may be further configured to enable CycMapping or SeqMapping in RepTClMapping. When CycMapping is enabled, the first and second TCI states are applied to the first and second PDSCH transmission occasions, respectively, and the same TCI mapping pattern continues to the remaining PDSCH transmission occasions. When SeqMapping is enabled, first TCI state is applied to the first and second PDSCH transmissions, and the second TCI state is applied to the third and fourth PDSCH transmissions, and the same TCI mapping pattern continues to the remaining PDSCH transmission occasions. The UE may expect that each PDSCH transmission occasion is limited to two transmission layers. For all PDSCH transmission occasions associated with the first TCI state, the redundancy version to be applied is derived according to Table 5.1.2.1-2 in TS 38.214, where n is counted only considering PDSCH transmission occasions associated with the first TCI state. The redundancy version for PDSCH transmission occasions associated with the second TCI state is derived according to Table 5.1.2.1-3 in TS 38.214, where additional shifting operation for each redundancy version rvₛ is configured by higher layer parameter RVSeqOffset and n is counted only considering PDSCH transmission occasions associated with the second TCI state.

And if one TCI state is indicated by the DCI field ‘Transmission Configuration Indication’ together with the DCI field “Time domain resource assignment’ indicating an entry in pdsch-TimeDomainAllocationList which contain RepNumR16 in PDSCH-TimeDomainResourceAllocation and DM-RS port(s) within one CDM group in the DCI field “Antenna Port(s)”, the same SLIV is applied for all PDSCH transmission occasions, the first PDSCH transmission occasion follows Clause “Resource allocation in time domain” (for example, clause 5.1.2.1) in TS 38.214, the same TCI state is applied to all PDSCH transmission occasions. The UE may expect that each PDSCH transmission occasion is limited to two transmission layers. For all PDSCH transmission occasions, the redundancy version to be applied is derived according to Table 5.1.2.1-2 in TS 38.214, where n is counted considering PDSCH transmission occasions.

Otherwise, the UE is expected to receive a single PDSCH transmission occasion, and the resource allocation in the time domain follows Clause “Resource allocation in time domain” (for example, clause 5.1.2.1) in TS 38.214.

In some embodiments, for a UE configured by the higher layer parameter RepSchemeEnabler set to ‘FDMSchemeA’ or ‘FDMSchemeB’, and when the UE is indicated with two TCI states in a codepoint of the DCI field ‘Transmission Configuration Indication and DM-RS port(s) within one CDM group in the DCI field “Antenna Port(s)”, or when the UE is assumed with two TCI states corresponding to the lowest codepoint among the TCI codepoints containing two different TCI states as described in Clause “Antenna ports quasi co-location” (for example, Clause 5.1.5) in TS 38.214. If P′_{BWP,i} is determined as “wideband”, the first ┌n_{PRB}/2┐ PRBs are assigned to the first TCI state and the remaining └n_{PRB}/2┘ PRB are assigned to the second TCI state, where n_{PRB} is the total number of allocated PRBs for the UE. If P′_{BWP,i} is determined as one of the values among {2, 4}, even PRGs within the allocated frequency domain resources are assigned to the first TCI state and odd PRGs within the allocated frequency domain resources are assigned to the second TCI state. The UE is not expected to receive more than two PDSCH transmission layers for each PDSCH transmission occasion.

In some embodiments, for a UE configured by the higher layer parameter RepSchemeEnabler set to ‘FDMSchemeB’, and when the UE is indicated with two TCI states in a codepoint of the DCI field ‘Transmission Configuration Indication or when the UE is assumed with two TCI states corresponding to the lowest codepoint among the TCI codepoints containing two different TCI states as described in Clause “Antenna ports quasi co-location” (for example, Clause 5.1.5) in TS 38.214, and DM-RS port(s) within one CDM group in the DCI field “Antenna Port(s)”, each PDSCH transmission occasion shall follow the Clause “Physical downlink shared channel” (for example Clause 7.3.1) of [TS 38.211] with the mapping to resource elements determined by the assigned PRBs for corresponding TCI state of the PDSCH transmission occasion, and the UE shall only expect at most two code blocks per PDSCH transmission occasion when a single transmission layer is scheduled and a single code block per PDSCH transmission occasion when two transmission layers are scheduled. For two PDSCH transmission occasions, the redundancy version to be applied is derived according to Table 5.1.2.1-2 in TS 38.214, where n=0, 1 are applied to the first and second TCI state, respectively.

In some embodiments, for a UE configured with FDMSchemeB, and when the UE is indicated with two TCI states in a codepoint of the DCI field ‘Transmission Configuration Indication or when the UE is assumed with two TCI states corresponding to the lowest codepoint among the TCI codepoints containing two different TCI states as described in Clause “Antenna ports quasi co-location” (for example, Clause 5.1.5) in TS 38.214, and DM-RS port(s) within one CDM group in the DCI field “Antenna Port(s)”, the determined modulation order of PDSCH transmission occasion associated with the first TCI state is applied to the PDSCH transmission occasion associated with the second TCI state.

In some embodiments, for a UE configured with FDMSchemeB and when the UE is indicated with two TCI states in a codepoint of the DCI field ‘Transmission Configuration Indication or when the UE is assumed with two TCI states corresponding to the lowest codepoint among the TCI codepoints containing two different TCI states as described in Clause “Antenna ports quasi co-location” (for example, Clause 5.1.5) in TS 38.214, and DM-RS port(s) within one CDM group in the DCI field “Antenna Port(s)”, the TBS determination follows the steps 1-4 with the following modification in step 1: a UE determines the total number of REs allocated for PDSCH (N_{RN}) by N_{RE}=min (156, N′_{RE})·n_{PRB}, where nPRB is the total number of allocated PRBs corresponding to the first TCI state. and the determined TBS of PDSCH transmission occasion associated with the first TCI state is also applied to the PDSCH transmission occasion associated with the second TCI state.

In some embodiments, when a UE configured by the higher layer parameter RepSchemeEnabler set to ‘FDMSchemeA’ or ‘FDMSchemeB’, and when the UE is the UE is indicated with two TCI states in a codepoint of the DCI field ‘Transmission Configuration Indication or when the UE is assumed with two TCI states corresponding to the lowest codepoint among the TCI codepoints containing two different TCI states as described in Clause “Antenna ports quasi co-location” (for example, Clause 5.1.5) in TS 38.214, and DM-RS port(s) within one CDM group in the DCI field “Antenna Port(s)”, the UE shall receive a single PT-RS port which is associated with the lowest indexed DM-RS antenna port among the DM-RS antenna ports assigned for the PDSCH, a PT-RS frequency density is determined by the number of PRBs associated to each TCI state, and a PT-RS resource element mapping is associated to the allocated PRBs for each TCI state.

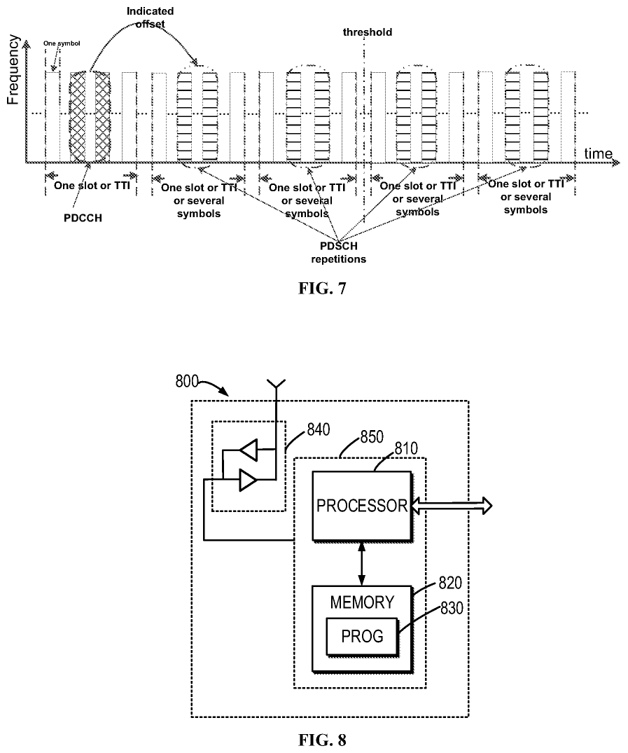

FIG. 8 is a simplified block diagram of a device 800 that is suitable for implementing embodiments of the present disclosure. The device 800 can be considered as a further example implementation of the network device 110, the TRP 120 or the terminal device 130 as shown in FIG. 1. Accordingly, the device 800 can be implemented at or as at least a part of the network device 110, the TRP 120 or the terminal device 130.

As shown, the device 800 includes a processor 810, a memory 820 coupled to the processor 810, a suitable transmitter (TX) and receiver (RX) 840 coupled to the processor 810, and a communication interface coupled to the TX/RX 840. The memory 810 stores at least a part of a program 830. The TX/RX 840 is for bidirectional communications. The TX/RX 840 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 830 is assumed to include program instructions that, when executed by the associated processor 810, enable the device 800 to operate in accordance with the embodiments of the present disclosure, as discussed herein with reference to FIGS. 1 to 7. The embodiments herein may be implemented by computer software executable by the processor 810 of the device 800, or by hardware, or by a combination of software and hardware. The processor 810 may be configured to implement various embodiments of the present disclosure. Furthermore, a combination of the processor 810 and memory 820 may form processing means 850 adapted to implement various embodiments of the present disclosure.

The memory 820 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 6-7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method of communication, comprising:
receiving, at a first device, control information from a second device for scheduling a plurality of transmission occasions of a physical shared channel;
determining, a plurality of transmission control indication (TCI) states to be used for the plurality of transmission occasions;
in response to the plurality of transmission occasions of the physical shared channel being configured to be scheduled by the control information, determining, from the plurality of transmission occasions of the physical shared channel, a set of transmission occasions of the physical shared channel associated with one TCI state of the plurality of TCI states;
receiving, at least based on the TCI state, the plurality of transmission occasions from the second device over the physical shared channel.

2. A device, comprising:
a processing unit; and
a memory coupled to the processing unit and storing instructions thereon, the instructions, when executed by the processing unit, causing the device to perform:
receiving, at a first device, control information from a second device for scheduling a plurality of transmission occasions of a physical shared channel;
determining, a plurality of transmission control indication (TCI) states to be used for the plurality of transmission occasions;
in response to the plurality of transmission occasions of the physical shared channel being configured to be scheduled by the control information, determining, from the plurality of transmission occasions of the physical shared channel, a set of transmission occasions of the physical shared channel associated with one TCI state of the plurality of TCI states;
receiving, at least based on the TCI state, the plurality of transmission occasions from the second device over the physical shared channel.

3. A computer readable medium having instructions stored thereon, the instructions, when executed on at least one processor, causing the at least one processor to carry out the method according to claims 1.
